(19) United States
(12) Patent Application Publication
(10) Pub. No.: US 2025/0350042 A1
(43) Pub. Date: Nov. 13, 2025

(54) Power Transmission Vehicle Device

(71) Applicant: Hunan Huaxia Tebian Co., Ltd., Xiangtan (CN)

(72) Inventors: Xiangbin XIA, Xiangtan (CN); Fuque XIA, Xiangtan (CN)

(21) Appl. No.: 19/274,897

(22) Filed: Jul. 21, 2025

Related U.S. Application Data
(63) Continuation of application No. PCT/CN2024/081601, filed on Mar. 14, 2024.

(30) Foreign Application Priority Data
Mar. 16, 2023 (CN) 202310253914.8
Mar. 16, 2023 (CN) 202320508646.5
Mar. 16, 2023 (CN) 202320508912.4
Aug. 4, 2023 (CN) 202322087391.2
Aug. 9, 2023 (CN) 202322132780.2
Oct. 8, 2023 (CN) 202322688537.9
Oct. 8, 2023 (CN) 202322688552.3
Nov. 14, 2023 (CN) 202311512644.4

(51) Int. Cl. H01R 4/28

(52) U.S. Cl. CPC H01R 4/28; H05B 2203/016

(57) ABSTRACT

The present application discloses a power transmission vehicle device, including a vehicle body, electrode clamping mechanisms and power transmission busbar clamping mechanisms. The electrode clamping mechanisms and the power transmission busbar clamping mechanisms are arranged on the vehicle body, the electrode clamping mechanisms are used for clamping conducting electrodes, the power transmission busbar clamping mechanisms and the electrode clamping mechanisms are connected through connecting cables, each power transmission busbar clamping mechanism includes a busbar clamping component, and the busbar clamping component is used for clamping a power transmission busbar. When it is not necessary to supply power to Acheson graphitization furnaces, the power-off operation of the conducting electrodes can be completed only by loosening the electrode clamping mechanisms and/or the power transmission busbar clamping mechanisms, which effectively improves the convenience of power supply to the Acheson graphitization furnaces.

### CROSS REFERENCE TO RELATED APPLICATIONS

The present application claims the priority from Chinese application No. CN202311512644.4, titled “Aluminum Busbar Lower-clamping Power Transmission Vehicle Device”, filed on Nov. 14, 2023 to CNIPA, Chinese application No. CN202310253914.8, titled “Contact-type Copper-aluminum Busbar Clamping Device”, filed on March 16, 2023 to CNIPA, Chinese application No. CN202322688552.3, titled “Aluminum Busbar Side-clamping Structure of Power Transmission Vehicle”, filed on Oct. 8, 2023 to CNIPA, Chinese application No. CN202322688537.9, titled “Aluminum Busbar Clamping Plate Cooling Structure. Power Transmission Aluminum Busbar Clamping Mechanism and Power Transmission Trolley”, filed on Oct. 8, 2023 to CNIPA. Chinese application No. CN202322132780.2, titled “Frame Structure for Power Transmission Vehicle and Power Transmission Vehicle”, filed on Aug. 9, 2023 to CNIPA. Chinese application No. CN202322087391.2, titled “Copper-aluminum Power Transmission Busbar Clamping Mechanism with Adjustable Height and Power Transmission Vehicle”, filed on Aug. 4, 2023 to CNIPA, Chinese application No. CN202320508646.5. titled “Electrode Clamp Opening Structure and Electrode Clamping Device”, filed on Mar. 16, 2023 to CNIPA, and Chinese application No. CN202320508912.4, titled “Water Cooling Clamping Plate for Furnace End Electrode and Fixture”, filed on Mar. 16, 2023 to CNIPA, which are incorporated herein by reference in their entirety.

### TECHNICAL FIELD

The present application relates to the technical field of power transmission devices for Acheson graphitization furnaces, in particular to a power transmission vehicle device.

### BACKGROUND

An Acheson graphitization furnace is a device that transforms amorphous carbon into layered and regularly arranged graphite structure by high temperature. An Acheson furnace is a kind of Acheson graphitization furnace, the Acheson graphitization furnace has a cuboid-shaped furnace body and conducting electrodes arranged at the furnace head and the furnace tail, and the conducting electrodes on both ends of the Acheson graphitization furnace need to be directly connected with a power transmission busbar to obtain high current.

One existing technical solution is to fix copper plates with a flexible coupling on the conducting electrodes of an Acheson graphitization furnace and a power transmission busbar by bolts to form a power transmission switch (commonly called a knife switch). When it is necessary to supply power to a furnace, the flexible coupling of the copper plate should be bent and fixed together with a busbar by bolts, and then tightened with nuts. When it is necessary to supply power to another furnace, the furnace in use shall be powered off, then the copper plate is separated from the busbar, and a power transmission switch (knife switch) of another furnace is connected and fixed, which takes a long time of 2 to 3 hours and easily causes damage to the power transmission busbar.

In view of this, it is necessary to propose a power transmission vehicle device to solve the above technical problem.

### SUMMARY

Based on this, the purpose of the present application is to provide a power transmission vehicle device, which effectively improves the convenience of power supply to Acheson graphitization furnaces and prolongs the service life of power transmission busbars.

To solve the above technical problem, the present application adopts the following technical solution: a power transmission vehicle device, comprising a vehicle body, electrode clamping mechanisms and power transmission busbar clamping mechanisms, wherein the electrode clamping mechanisms and the power transmission busbar clamping mechanisms are arranged on the vehicle body, the electrode clamping mechanisms are used for clamping conducting electrodes, the power transmission busbar clamping mechanisms and the electrode clamping mechanisms are electrically connected, each power transmission busbar clamping mechanism comprises a busbar clamping component, and the busbar clamping component is used for clamping a power transmission busbar.

Compared with the prior art, the power transmission vehicle device of the present application comprises a vehicle body, electrode clamping mechanisms and power transmission busbar clamping mechanisms, the electrode clamping mechanisms and the power transmission busbar clamping mechanisms are arranged on the vehicle body, the electrode clamping mechanisms are used for clamping conducting electrodes, the power transmission busbar clamping mechanisms and the electrode clamping mechanisms are connected through connecting cables, each power transmission busbar clamping mechanism comprises a busbar clamping component, and the busbar clamping component is used for clamping a power transmission busbar; and the present application drives the electrode clamping mechanisms through the vehicle body to move to conducting electrodes, clamps the conducting electrodes by the electrode clamping mechanisms, and clamps power transmission busbars by the power transmission busbar clamping mechanisms, so as to transmit power delivered by the power transmission busbars to the conducting electrodes through the power transmission busbar clamping mechanisms and the electrode clamping mechanisms. When it is not necessary to supply power to Acheson graphitization furnaces, the power-off operation of the conducting electrodes can be completed only by loosening the electrode clamping mechanisms and/or the power transmission busbar clamping mechanisms, which effectively improves the convenience of power supply to the Acheson graphitization furnaces.

### DESCRIPTION OF DRAWINGS

FIG. 1 is a structural schematic diagram of a power transmission vehicle device of the present application;

FIG. 2 is a structural schematic diagram from another perspective of a power transmission vehicle device of the present application;

FIG. 3 is a structural schematic diagram of a power transmission vehicle device provided in embodiment 1 of the present application;

FIG. 4 is a structural schematic diagram of a busbar clamping component provided in embodiment 1 of the present application;

FIG. 5 is a structural schematic diagram of another power transmission vehicle device provided in embodiment 1 of the present application;

FIG. 6 is a structural schematic diagram of another power transmission vehicle device with hidden electrode clamping mechanisms provided in embodiment 1 of the present application;

FIG. 7 is a structural combined diagram of a busbar clamping component and a crossbeam provided in embodiment 1 of the present application;

FIG. 8 is a structural schematic diagram of a connecting frame provided in embodiment 1 of the present application;

FIG. 9 is a structural schematic diagram of a busbar clamping component provided in embodiment 1 of the present application;

FIG. 10 is a schematic diagram of a working scenario of a power transmission vehicle device provided in embodiment 2 of the present application;

FIG. 11 is a structural schematic diagram from the first perspective of a power transmission vehicle device provided in embodiment 2 of the present application;

FIG. 12 is a structural schematic diagram from the second perspective of a power transmission vehicle device provided in embodiment 2 of the present application;

FIG. 13 is a structural schematic diagram from the first perspective of a first kind of busbar clamping component provided in embodiment 2 of the present application;

FIG. 14 is a structural schematic diagram from the second perspective of a first kind of busbar clamping component provided in embodiment 2 of the present application;

FIG. 15 is a structural schematic diagram of a second kind of busbar clamping component corresponding to a fixing seat provided in embodiment 2 of the present application;

FIG. 16 is a structural schematic diagram of a second kind of busbar clamping component provided in embodiment 2 of the present application;

FIG. 17 is a structural schematic diagram of a busbar clamping component provided in embodiment 2 of the present application;

FIG. 18 is a structural schematic diagram of a busbar clamping component provided in embodiment 3 of the present application;

FIG. 19 is a structural schematic diagram of a busbar clamping plate provided in embodiment 3 of the present application;

FIG. 20 is a structural exploded diagram of a busbar clamping plate provided in embodiment 3 of the present application;

FIG. 21 is a structural state diagram of a busbar clamping component clamping a power transmission busbar provided in embodiment 3 of the present application;

FIG. 22 is a structural schematic diagram of a busbar clamping component provided in embodiment 4 of the present application;

FIG. 23 is a structural schematic diagram of a busbar clamping plate provided in embodiment 4 of the present application;

FIG. 24 is a structural exploded diagram of a busbar clamping plate provided in embodiment 4 of the present application;

FIG. 25 is a structural state diagram of a busbar clamping component clamping a conducting busbar provided in embodiment 4 of the present application;

FIG. 26 is a structural schematic diagram of a first clamping plate fixedly connected to a first clamping arm provided in embodiment 4 of the present application;

FIG. 27 is a structural schematic diagram of another V-clamp structure provided in embodiment 4 of the present application;

FIG. 28 is a structural schematic diagram of a push-type structure provided in embodiment 4 of the present application;

FIG. 29 is a state schematic diagram of a busbar clamping component installed on a crossbeam of a vehicle body provided in embodiment 4 of the present application;

FIG. 30 is a structural schematic diagram of a busbar clamping component provided in embodiment 4 of the present application (a first driving part is omitted);

FIG. 31 is a structural schematic diagram of a busbar clamping plate provided in embodiment 5 of the present application;

FIG. 32 is a combined schematic diagram of a first kind of conducting head and a first conducting plate provided in embodiment 5 of the present application;

FIG. 33 is a combined schematic diagram of a second kind of conducting head and a first conducting plate when only one first conducting head and one second conducting head are available provided in embodiment 5 of the present application;

FIG. 34 is a structural schematic diagram of a first conducting head or a second conducting head provided in embodiment 5 of the present application;

FIG. 35 is a structural schematic diagram of a second kind of busbar clamping plate provided in embodiment 5 of the present application;

FIG. 36 is a combined schematic diagram of a second kind of conducting head and a first conducting plate provided in embodiment 5 of the present application;

FIG. 37 is a structural schematic diagram of a busbar clamping component provided in embodiment 5 of the present application;

FIG. 38 is a structural schematic diagram of a busbar clamping component provided in embodiment 6 of the present application;

FIG. 39 is a structural schematic diagram of a busbar clamping component with a hidden first driving part provided in embodiment 6 of the present application;

FIG. 40 is a structural schematic diagram of a base frame provided in embodiment 7 of the present application;

FIG. 41 is a structural schematic diagram of a base frame provided in embodiment 7 of the present application;

FIG. 42 is a structural schematic diagram of a base frame provided in embodiment 7 of the present application;

FIG. 43 is a structural schematic diagram of a power transmission vehicle device provided in embodiment 7 of the present application;

FIG. 44 is a structural schematic diagram of a power transmission busbar clamping mechanism provided in embodiment 8 of the present application;

FIG. 45 is a structural schematic diagram of a base frame provided in embodiment 8 of the present application;

FIG. 46 is a local enlarged view of a base frame provided in embodiment 8 of the present application;

FIG. 47 is a structural schematic diagram of a power transmission vehicle device provided in embodiment 8 of the present application.

### DETAILED DESCRIPTION

The technical solutions of the present application will be clearly and fully described below in combination with the drawings. Apparently, the described embodiments are part of the embodiments of the present application. not all of the embodiments. Based on the embodiments in the present application, all other embodiments obtained by those ordinary skilled in the art without contributing creative labor will belong to the protection scope of the present application.

It should be noted in the description of the present application that terms such as “central”, “upper”, “lower”, “left”, “right”, “vertical”, “horizontal”, “inner”, “outer”, etc. indicate direction or position relationships shown based on the drawings, and are only intended to facilitate the description of the present application and the simplification of the description rather than to indicate or imply that the indicated device or element must have a specific direction or constructed and operated in a specific direction, and therefore, shall not be understood as a limitation to the present application. In addition, the terms such as “first”, “second” and “third” are only used for the purpose of description, rather than being understood to indicate or imply relative importance.

It should be noted in the description of the present application that, unless otherwise specifically regulated and defined, terms such as “installation,” “connected,” and “connecting” shall be understood in broad sense, and for example, may refer to fixed connection or detachable connection or integral connection, may refer to mechanical connection or electrical connection, and may refer to direct connection or indirect connection through an intermediate medium or inner communication of two elements. For those ordinary skilled in the art, the specific meanings of the above terms in the present application may be understood according to specific conditions.

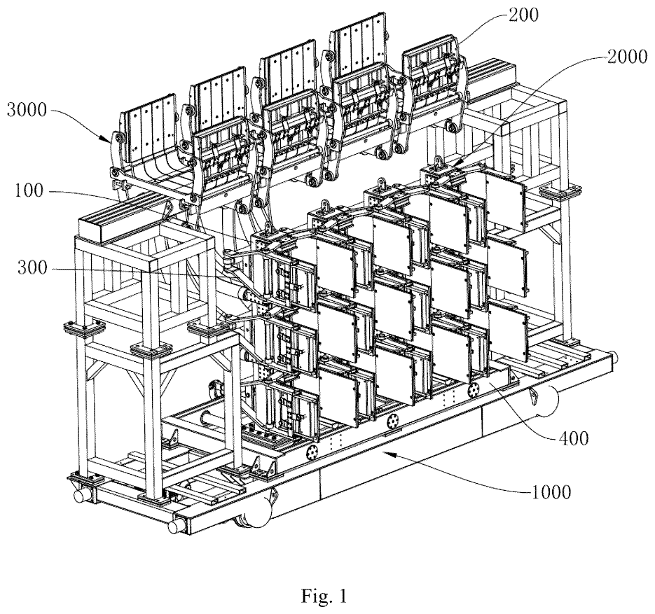

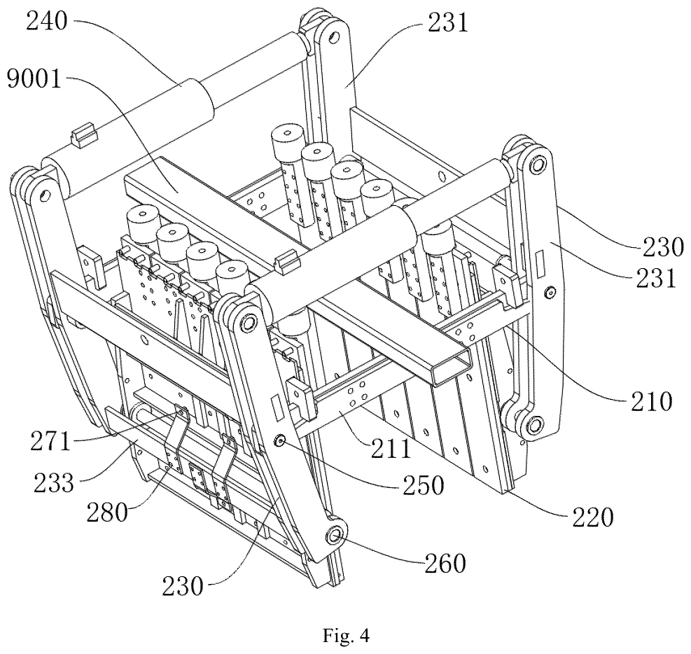

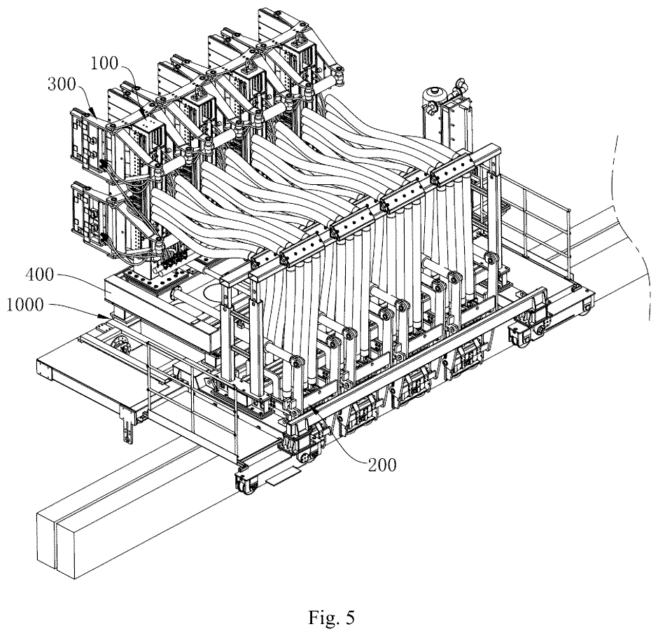

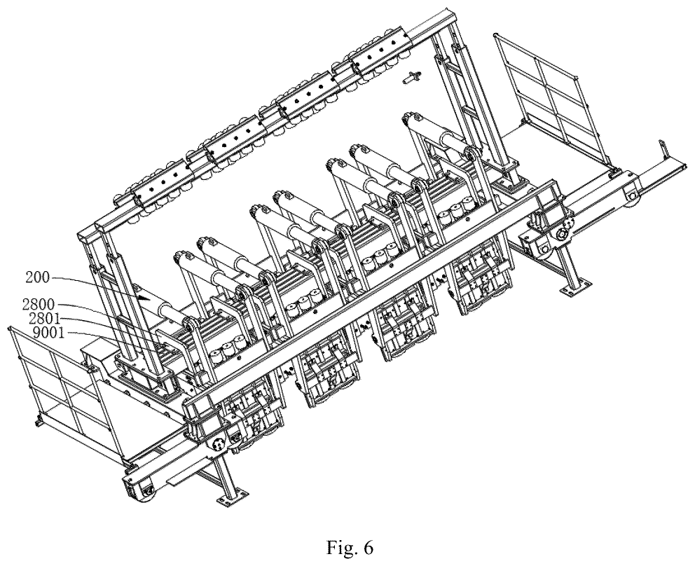

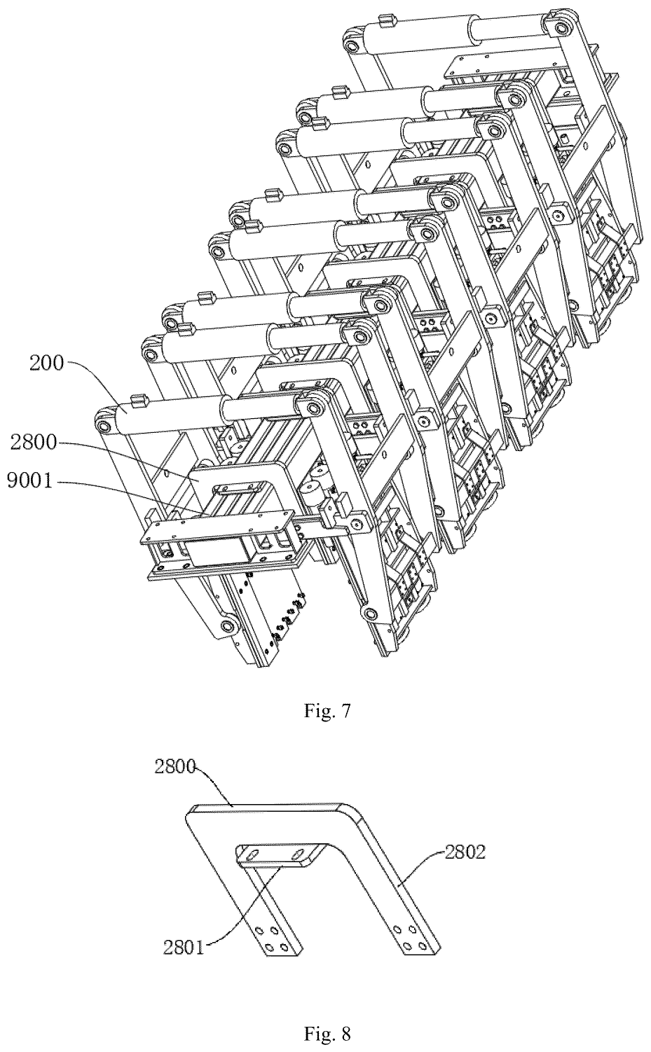

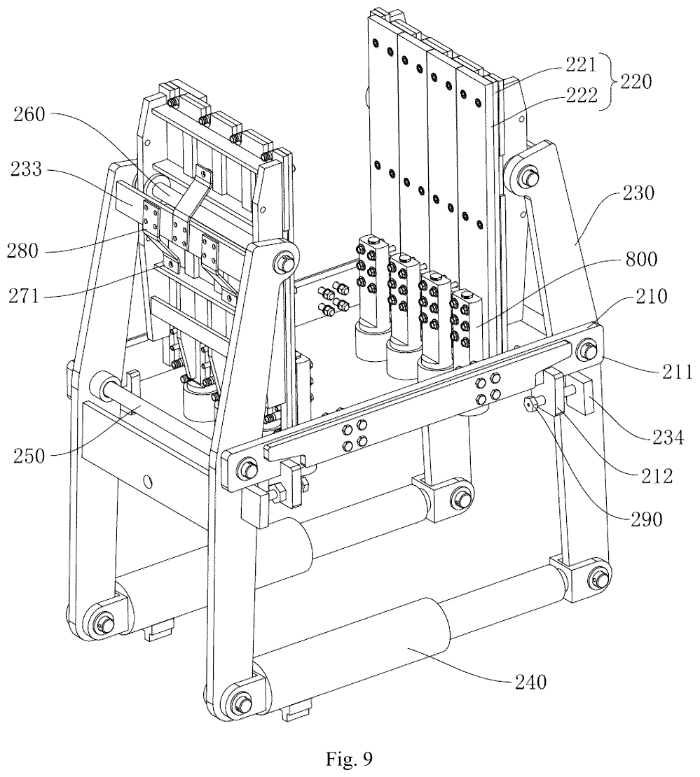

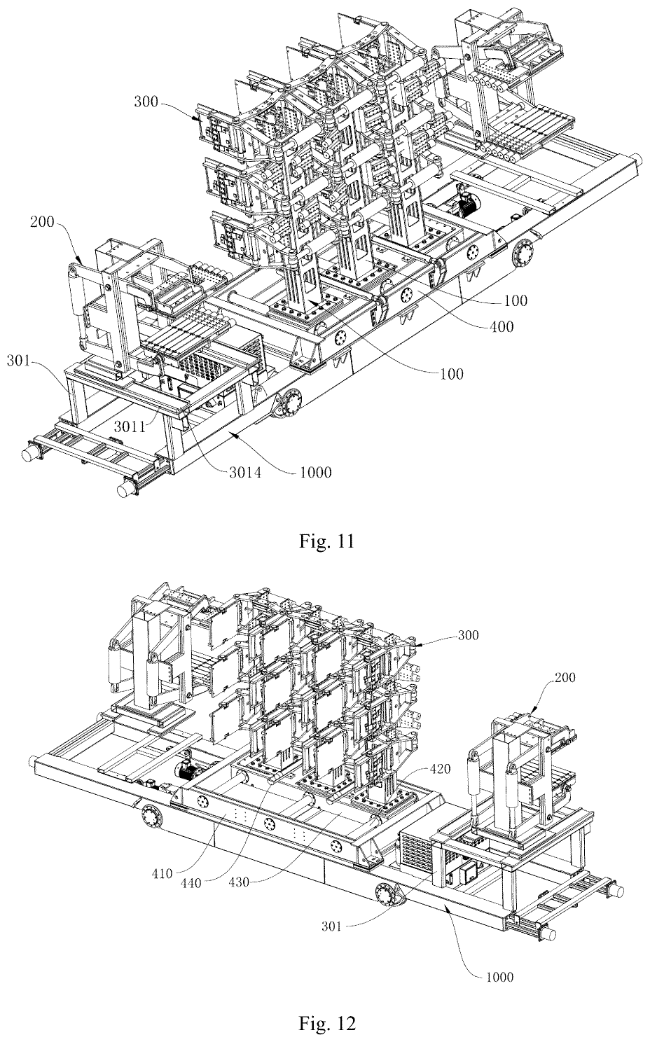

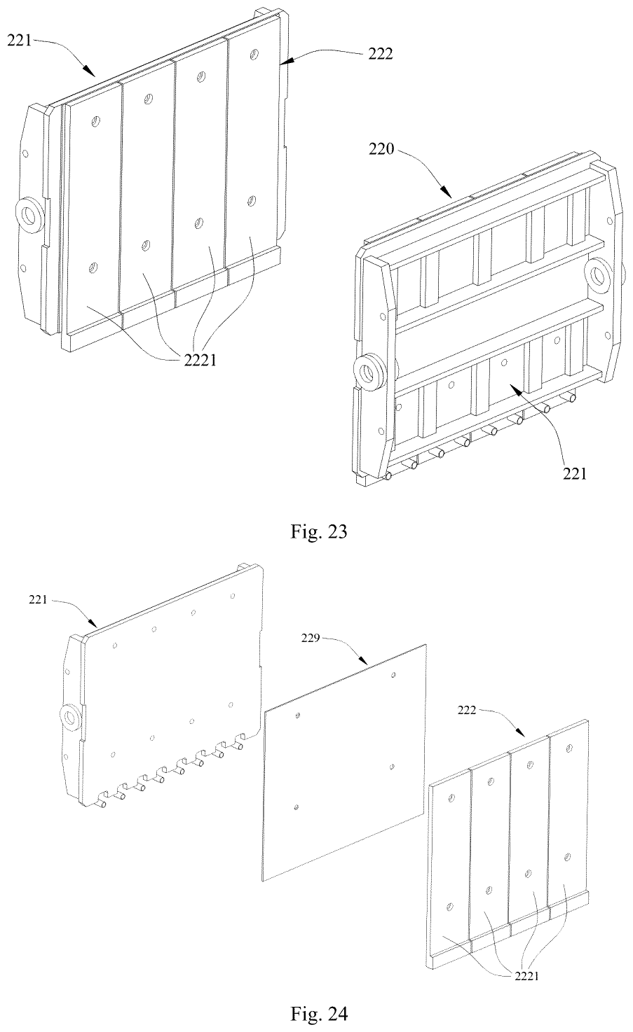

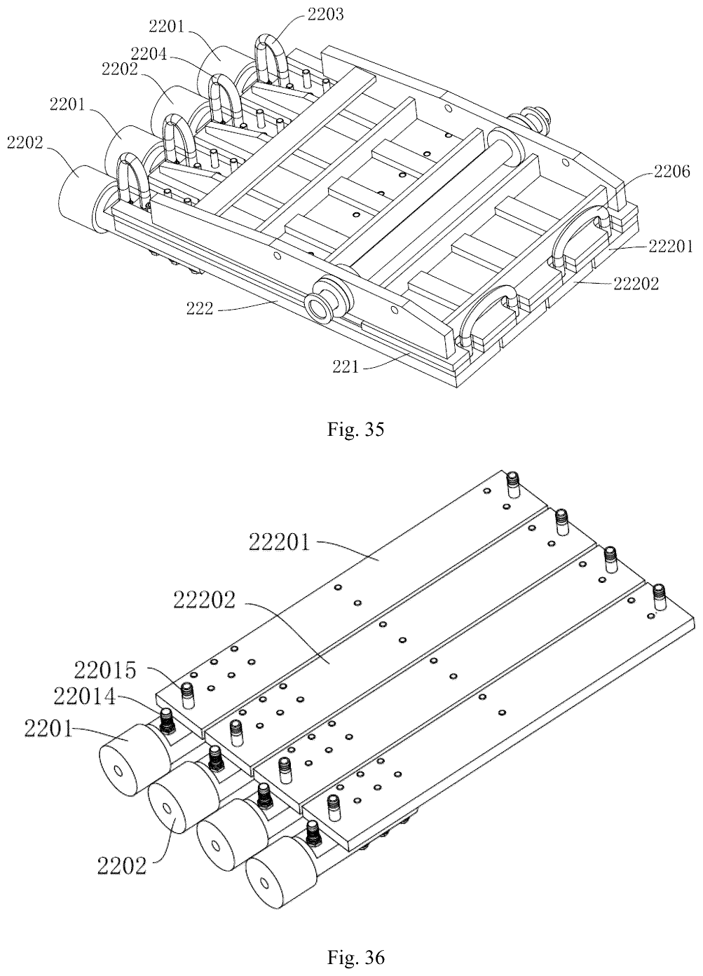

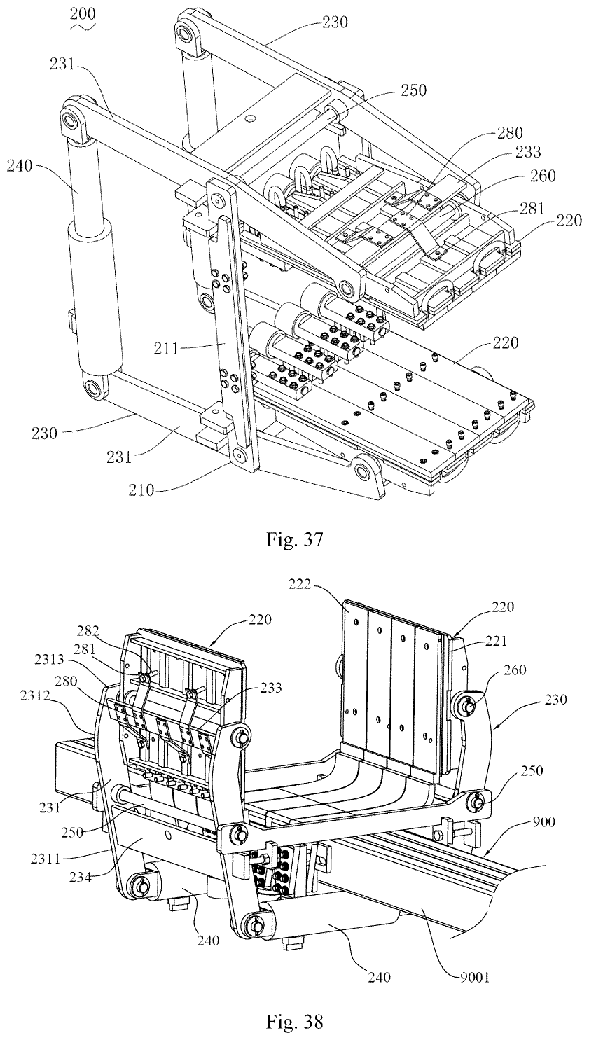

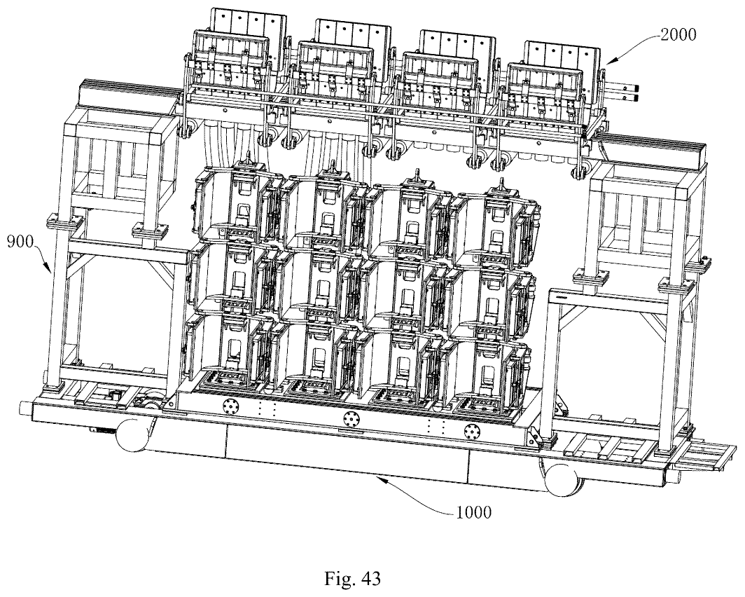

Referring to FIG. 1 to FIG. 47, the power transmission vehicle device of the present application is used for supplying power to Acheson graphitization furnaces. Exemplarily, a graphitization device is an Acheson graphitization furnace unit, which comprises a plurality of Acheson graphitization furnaces arranged side by side at intervals. Each Acheson graphitization furnace comprises a cuboid-shaped furnace body and conducting electrodes arranged on both end surfaces of the furnace body. The conducting electrodes are cuboid. The number of the conducting electrodes is nine, the conducting electrodes are distributed on the end surfaces of the furnace body in a square shape, the number of which can be set to two, four, six, etc, as required, and the number of the conducting electrodes protruding from the end surfaces of the furnace body is determined according to the layout of the conducting electrodes to be graphitized in the Acheson graphitization furnace.

A guide rail is arranged between a plurality of Acheson graphitization furnace units and in parallel to the Acheson graphitization furnace units. The power transmission vehicle device moves along the rail for power transmission to conducting electrodes of different Acheson graphitization furnaces.

Referring to FIG. 1, the power transmission vehicle device comprises: a vehicle body 1000, electrode clamping mechanisms 2000 and power transmission busbar clamping mechanisms 3000, wherein the vehicle body 1000 has a movement function to drive the whole power transmission vehicle device to move along the rail to transmit power to conducting electrodes of different Acheson graphitization furnaces. Moreover, the electrode clamping mechanisms 2000 and the power transmission busbar clamping mechanisms 3000 are arranged on the vehicle body 1000, and the vehicle body 1000 is used as a carrier to carry the electrode clamping mechanisms 2000 and the power transmission busbar clamping mechanisms 3000.

The electrode clamping mechanisms 2000 are used for clamping conducting electrodes, the power transmission busbar clamping mechanisms 3000 are used for clamping power transmission busbars, and the power transmission busbar clamping mechanisms 3000 and the electrode clamping mechanisms 2000 are electrically connected; specifically, the power transmission busbar clamping mechanisms 3000 and the electrode clamping mechanisms 2000 can be electrically connected through flexible couplings such as connecting cables and flexible busbars, so as to transmit power delivered by power transmission busbars to the electrode clamping mechanisms 2000 and then transmit power to the conducting electrodes by the electrode clamping mechanisms 2000, thus realizing the operation of power supply to the Acheson graphitization furnaces; and the electrode clamping mechanisms 2000 are driven through the vehicle body 1000 to move to the conducting electrodes, the conducting electrodes are clamped by the electrode clamping mechanisms 2000, and the power transmission busbars are clamped by the power transmission busbar clamping mechanisms 3000, so as to transmit power delivered by the power transmission busbars to the conducting electrodes through the power transmission busbar clamping mechanisms 3000 and the electrode clamping mechanisms 2000. When it is not necessary to supply power to the Acheson graphitization furnaces, the power-off operation of the conducting electrodes can be completed only by loosening the electrode clamping mechanisms 2000 and/or the power transmission busbar clamping mechanisms 3000, which effectively improves the convenience of power supply to the Acheson graphitization furnaces; in addition, the wear operation on the power transmission busbars in one existing technical solution of power transmission is avoided through the clamping and loosening operation by the power transmission busbar clamping mechanisms 3000 on the power transmission busbars, which effectively prolongs the service life of the power transmission busbars; and each power transmission busbar has a conducting structure of aluminum busbar or copper busbar, and in the application document, the power transmission busbar is specifically an aluminum power transmission busbar.

In one embodiment, the electrode clamping mechanisms 2000 are slidably connected with the vehicle body 1000, the electrode clamping mechanisms 2000 are arranged along the length direction of the vehicle body 1000, the vehicle body 1000 is provided with a sliding mechanism 400, and the electrode clamping mechanisms 2000 are pushed through the sliding mechanism 400 to slide out from one side of the vehicle body 1000 to be butted with the conducting electrodes of an Acheson graphitization furnace. After the end of power transmission, the electrode clamping mechanisms 2000 are loosened and driven back to the initial position by the sliding mechanism 400 to facilitate the electrode clamping mechanisms 2000 to clamp conducting electrodes in the next Acheson graphitization furnace for power transmission, which effectively improves the convenience of power supply to Acheson graphitization furnaces.

In one embodiment, each electrode clamping mechanism 2000 comprises a strut 100 and an electrode clamping component 300 arranged on the strut 100, the strut 100 is arranged on the vehicle body 1000, the electrode clamping component 300 is used for clamping a conducting electrode, the electrode clamping component 300 is arranged on the strut 100, and the electrode clamping component 300 can adapt to the deformation of the conducting electrode to carry out the corresponding operation when clamping the conducting electrode, so as to achieve an effect of stably clamping the conducting electrode by the electrode clamping mechanism; each power transmission busbar clamping mechanism 3000 comprises a busbar clamping component 200, the busbar clamping component 200 is used for clamping a power transmission busbar, and the busbar clamping component 200 and the electrode clamping component 300 are connected through connecting cables, so as to transmit power delivered by the power transmission busbars to the electrode clamping component 300 and then transmit power to the conducting electrodes by the electrode clamping component 300, thus realizing the operation of power supply to the Acheson graphitization furnaces; and the electrode clamping mechanisms 2000 are driven through the vehicle body 1000 to move to the conducting electrodes, the conducting electrodes are clamped by the electrode clamping components 300, and the power transmission busbars are clamped by the busbar clamping components 200, so as to transmit power delivered by the power transmission busbars to the conducting electrodes through the busbar clamping components 200 and the electrode clamping components 300. When it is not necessary to supply power to Acheson graphitization furnaces, the power-off operation of the conducting electrodes can be completed only by loosening the electrode clamping components 300 and/or the busbar clamping components 200, which effectively improves the convenience of power supply to the Acheson graphitization furnaces; in addition, since the conducting electrodes are replaced after graphitization, and the power transmission busbars are more cumbersome in replacement and maintenance, the wear operation on the power transmission busbars in one existing technical solution of power transmission is avoided through the clamping and loosening operation by the busbar clamping components 200 on the power transmission busbars, which effectively prolongs the service life of the power transmission busbars; and in the present embodiment, at least one electrode clamping component 300 is arranged as required, at least one strut 100 is arranged as required, a plurality of electrode clamping components 300 are arranged vertically on the struts 100, and a plurality of struts 100 are arranged on the vehicle body 1000 along the length direction of the vehicle body 1000 to match the position arrangement of the conducting electrodes on both end surfaces of the furnace body, for example, when the number of the struts 100 is set to three, and the number of the electrode clamping components 300 arranged vertically on the struts 100 is set to three, the operation of power supply to not more than nine conducting electrodes on both end surfaces of the furnace body can be realized.

### Embodiment 1

Different from conventional workpieces, a power transmission circuit needs to be connected with a power transmission busbar to obtain high current during power transmission. In an existing power transmission vehicle, a busbar fixture is arranged at the top of a vehicle frame to be connected with a power transmission busbar, the clamping opening of the busbar fixture is arranged upward to facilitate the clamping of the power transmission busbar, but the arrangement of the busbar fixture at the top of the vehicle frame often greatly increases the overall installation height of the power transmission vehicle, and the installation height of the power transmission busbar will also be increased if the power transmission vehicle with the busbar fixture arranged at the top of the vehicle frame is placed in a work site. The adaptive installation of the power transmission busbar cannot be completed or the installation difficulty of the power transmission busbar is increased in the presence of a height limit in the installation site of an Acheson graphitization furnace, and the power transmission vehicle with the busbar fixture arranged at the top of the vehicle frame cannot be used effectively. In this way, the present embodiment specifically adopts the following structure to solve the problem that the adaptive installation of the power transmission busbar cannot be completed or the installation difficulty of the power transmission busbar is increased in the presence of a height limit in the installation site of the Acheson graphitization furnace.

Referring to FIG. 3 to FIG. 9, the power transmission busbar clamping mechanism 3000 also comprises a base frame 900, and the bottom end of the base frame 900 is hollow to facilitate the installation of a power transmission busbar through a space below the base frame 900.

A strut 100 is arranged on the base frame 900; and specifically, the middle part of the base frame 900 is provided with a sliding mechanism 400, and the sliding mechanism 400 comprises a support frame body 410, at least one support shaft 420, a moving mechanism 430 and a driving mechanism 440. A moving space 410a suitable for an electrode clamping mechanism 2000 is formed in the support frame body 410. At least one support shaft 420 is located in the moving space 410a and connected with the support frame body 410. The moving mechanism 430 is located in the moving space 410a and can move relative to the support shaft 420, and the moving mechanism 430 is configured to support and connect the electrode clamping mechanism 2000. The driving mechanism 440 is arranged on the support frame body 410 and is in driving connection with the moving mechanism 430, and the driving mechanism 440 is configured to drive the moving mechanism 430 to drive the electrode clamping mechanism 2000 to move along the axial direction of the support shaft 420, so as to drive the electrode clamping mechanism 2000 to clamp a conducting electrode. Further, the strut 100 is arranged on the moving mechanism 430 and moved back and forth along with the moving mechanism 430 along the axial direction of the support shaft 420.

Since the placement height of conducting electrodes on both ends of the Acheson graphitization furnace will not be changed, and in order to match the clamping of the conducting electrodes, the installation height of the electrode clamping mechanism will also not be changed, the present embodiment adopts a method for limiting the installation height of the upper end of the power transmission busbar clamping mechanism to reduce the overall height of the power transmission vehicle device under the conditions that the installation height of the electrode clamping mechanism is kept unchanged and that the installation site of the Acheson graphitization furnace has a height limit, and specifically adopts the following structure:

The base frame 900 is also provided with a crossbeam 9001, and a busbar clamping component 200 is arranged on the crossbeam 9001 and used for clamping a power transmission busbar; the height of the upper end of the crossbeam 9001 and the height of the upper end of the busbar clamping component 200 are less than that of the upper end of the strut 100, specifically, the crossbeam 9001 is arranged below the strut 100, and the installation height of the crossbeam 9001 is much less than that of the strut 100 so that the installation height of the busbar clamping component 200 can also be reduced, which effectively reduces the overall height of the power transmission vehicle, so as to avoid the problem that the overall height of the improved power transmission vehicle is greater than that of the existing power transmission vehicle to meet the requirement that the installation site of the Acheson graphitization furnace has a height limit; in addition, the busbar clamping component 200 is installed in conjunction with the height space of the structure of the base frame 900, which greatly saves space usage of the power transmission vehicle device; and moreover, the overall height of the power transmission vehicle is reduced to effectively avoid the problem that the overall center of gravity of the power transmission vehicle is too high, thus ensuring the stability of the power transmission vehicle.

In one embodiment, the busbar clamping opening of the busbar clamping component 200 is arranged towards the ground and kept at a certain distance from the ground. Under the initial condition, a power transmission busbar is located in the busbar clamping opening of the busbar clamping component 200 and kept at a certain distance from the busbar clamping component 200 to achieve an effect of avoiding preventing the power transmission vehicle device from moving along the ground rail due to continuous contact between the power transmission busbar and the busbar clamping component 200; since the busbar clamping opening of the busbar clamping component 200 is arranged towards the ground, the installation height of the busbar clamping component 200 is limited by the height of the structure of the base frame 900, which can effectively reduce the overall height of the power transmission vehicle, so as to avoid the problem that the overall height of the improved power transmission vehicle is greater than that of the existing power transmission vehicle to meet the requirement that the installation site of the Acheson graphitization furnace has a height limit; in addition, the busbar clamping component 200 is installed in conjunction with the height space of the structure of the base frame 900, which greatly saves space usage of the power transmission vehicle device; and moreover, the overall height of the power transmission vehicle is reduced to effectively avoid the problem that the overall center of gravity of the power transmission vehicle is too high, thus ensuring the stability of the power transmission vehicle.

In one embodiment, both sides of the base frame 900 are provided with a limiting baffle plate 9002 respectively, the crossbeam 9001 is arranged above the limiting baffle plate 9002, the outside part of the busbar clamping opening of the busbar clamping component 200 is arranged near the two limiting baffle plates 9002, and the limiting baffle plates 9002 are used for limiting the width of the busbar clamping opening of the busbar clamping component 200, which, on one hand, reduces the volume of the assembled busbar clamping component 200 to facilitate transporting the power transmission vehicle device to different places, and on the other hand, protects the busbar clamping component 200 through the limiting baffle plates 9002 to protect the power transmission vehicle device against the influence of unexpected events such as bumping caused by too large width of the busbar clamping opening of the busbar clamping component 200 in use.

In other embodiments, the busbar clamping opening of the busbar clamping component 200 is arranged horizontally and kept at a certain distance from the ground to match the installation effect of the power transmission busbar; and accordingly, the crossbeam 9001 is also designed to match the horizontal arrangement of the busbar clamping opening, and the crossbeam 9001 is designed to achieve a fixing effect of the busbar clamping component 200, wherein the busbar clamping opening can be oriented horizontally towards the side with the conducting electrodes or as required, towards the side away from the conducting electrodes, and preferably, the busbar clamping opening is oriented horizontally towards the side away from the conducting electrodes so that the matched power transmission busbar can be kept at a certain distance from the conducting electrodes to avoid mutual interference between the two in use.

As shown in FIG. 3 to FIG. 9, in one embodiment, the busbar clamping component 200 comprises:
A first support frame 210, which is fixed on the crossbeam 9001;
Two busbar clamping plates 220 arranged oppositely, wherein the two busbar clamping plates 220 realize clamping operation of a power transmission busbar on a furnace body together; and in the present embodiment, the busbar clamping opening is surrounded by the two busbar clamping plates 220, and the two busbar clamping plates 220 are arranged in forward and backward directions;
Two first clamping arms 230, which are hinged with both sides of the first support frame 210 respectively, wherein the two busbar clamping plates 220 are arranged on the two first clamping arms 230 respectively; the first clamping arms 230 are arranged near the two limiting baffle plates 9002 to limit the width of the busbar clamping opening of the busbar clamping component 200, which, on one hand. reduces the volume of the assembled busbar clamping component 200 to facilitate transporting the power transmission vehicle device to different places, and on the other hand, protects the busbar clamping component 200 through the limiting baffle plates 9002 to protect the power transmission vehicle device against the influence of unexpected events such as bumping caused by too large width of the busbar clamping opening of the busbar clamping component 200 in use; and
A first driving part 240, which is arranged between the two first clamping arms 230 and connected with the two first clamping arms 230 respectively.

Both sides of the first support frame 210 are hinged with the middle parts of the two first clamping arms 230 respectively to form two supporting points, and the first clamping arms 230 and the first support frame 210 are all sheet plates in a long strip shape; and both ends of the first driving part 240 are hinged on first ends of the two first clamping arms 230 respectively, and the first ends of the two first clamping arms 230 can be driven by the first driving part 240 to open and close around the supporting points, so as to drive the two busbar clamping plates 220 to be close to or away from each other, thus realizing clamping or loosening operation on the power transmission busbar. The first driving part 240 is a hydraulic cylinder in the present embodiment, and of course, can be a lead screw or a pneumatic cylinder in other embodiments, which will not be repeated herein.

Both sides of the first support frame 210 are hinged with the first clamping arm 230 on the corresponding side respectively through a first rotating shaft 250, and the first rotating shaft 250 forms the supporting point as described above.

Each busbar clamping plate 220 is hinged on the end of the first clamping arm 230 on the corresponding side through a second rotating shaft 260, and can swing around the second rotating shaft 260; specifically, the second rotating shaft 260 is arranged in the middle of the busbar clamping plate 220, both ends of the second rotating shaft 260 are connected with the first clamping arms 230 respectively. and the busbar clamping plates 220 rotate with the second rotating shaft 260 as an axis; and when the first driving part 240 drives the first clamping arms 230 to approach each other, the busbar clamping plates 220 on the first clamping arms 230 will gradually approach the power transmission busbar, and the busbar clamping plates 220 will rotate with the second rotating shaft 260 as an axis for self-adjustment according to actual needs to ensure close fit with the power transmission busbar, so as to maximize the contact area of the busbar clamping plate 220 and the power transmission busbar, thus increasing the electrical conduction efficiency.

In one embodiment, each first clamping arm 230 is provided with a first elastomer 280, the first elastomer 280 has a shrapnel structure, a first limiting part 271 is extended from the first elastomer 280 in a bending manner, the first limiting part 271 is abutted against one side of the busbar clamping plate 220, and the first limiting part 271 is used for limiting the initial installation angle of the busbar clamping plate 220, so as to adapt to the width setting of the power transmission busbar.

In one embodiment, the first limiting parts 271 of at least two first elastomers 280 are arranged on both sides of the first rotating shaft 250 respectively, so as to ensure that the busbar clamping plate 220 is withstood by the first limiting part 271 on the corresponding side when rotating forwards or backwards with the first rotating shaft 250 as an axis, thus ensuring that the opening corresponding to the initial installation angle of the busbar clamping plate 220 on the first clamping arm 230 is suitable for the width of the power transmission busbar, and before the power transmission busbar is clamped by the busbar clamping plates 220, the width of the opening between the busbar clamping plates 220 can adapt to the size of the power transmission busbar; and when the power transmission busbar is clamped by the busbar clamping plates 220, the busbar clamping plates 220 can form a stable fit relationship with the power transmission busbar to ensure the contact area of the busbar clamping plates 220 and the power transmission busbar.

In one embodiment, each first clamping arm 230 is provided with a first fixing plate 233, the first elastomers 280 are arranged on the first fixing plate 233 at intervals, the first limiting parts 271 located on both sides of the first fixing plate 233 are also arranged on both sides of the first rotating shaft 250 respectively, so as to ensure that the busbar clamping plate 220 is withstood by the first limiting part 271 on the corresponding side when rotating forwards or backwards with the first rotating shaft 250 as an axis, thus ensuring that the opening corresponding to the initial installation angle of the busbar clamping plate 220 on the first clamping arm 230 is suitable for the width of the power transmission busbar, and before the power transmission busbar is clamped by the busbar clamping plates 220, the width of the opening between the busbar clamping plates 220 can adapt to the size of the power transmission busbar; and when the power transmission busbar is clamped by the busbar clamping plates 220, the busbar clamping plates 220 can form a stable fit relationship with the power transmission busbar to ensure the contact area of the busbar clamping plates 220 and the power transmission busbar.

In other embodiments, the first elastomers 280 are arranged on the first clamping arms 230 to match both ends of the busbar clamping plate 220 to limit both ends of the busbar clamping plate 220 respectively, so as to limit the initial installation angle of the busbar clamping plate 220, thus meeting the width requirement of the power transmission busbar.

In one embodiment, the first fixing plate 233 is provided with fixing holes, one end of each first elastomer 280 is fixed on the first fixing plate 233 through screws, and the screws pass through one end of the first elastomer 280 and are stuck in the fixing holes.

In one embodiment, the first limiting part 271 is provided with screw holes, a first adjusting bolt is arranged in each screw hole, the first adjusting bolt is stuck in the screw hole, one end of the first adjusting bolt is abutted against one side of the busbar clamping plate 220, and the initial installation angle of the busbar clamping plate 220 is adjusted by adjusting the length of one end of the first adjusting bolt extending from the screw hole, so as to adapt to power transmission busbars of different sizes.

Further, the first support frame 210 comprises two first support plates 211 arranged in parallel, and the two first support plates 211 are fixed on the crossbeam 9001 respectively; each first clamping arm 230 comprise a first gripper arm 231, the busbar clamping plate 220 is arranged on one end of two first gripper arms 231 on the same side, both ends of the first driving part 240 are hinged on the other end of the first gripper arms 231 of the two first clamping arms 230 respectively, and first ends of the first gripper arms 231 can be driven by the first driving part 240 to open and close around the first rotating shaft 250, so as to drive the two busbar clamping plates 220 to be close to or away from each other, thus realizing clamping or loosening operation on the power transmission busbar by the power transmission busbar clamping mechanism; the first rotating shaft 250 is hinged between the two first gripper arms 231 on the same side and arranged by penetrating the first support plate 211, and both ends of the first rotating shaft 250 are connected with the middle parts of the two first gripper arms 231 respectively; in the present embodiment, the number of the first driving parts 240 is two, and both ends of each first driving part 240 are connected with the first gripper arms 231 respectively; and in other embodiments, the number of the first driving parts 240 can also be designed as one, the first clamping arm 230 can be formed by connecting the two first gripper arms 231 through a connecting rod, both ends of each first driving part 240 are connected with two connecting rods respectively, and the two connecting rods are driven to move so as to drive the two first clamping arms 230 to be close to or away from each other.

In other embodiments, the first support frame 210 is fixed on the crossbeam 9001 through a connecting frame 2800, specifically, the connecting frame 2800 has a U-shaped structure, the connecting frame 2800 is provided with a connecting piece 2801, the connecting frame 2800 is fixedly arranged on the crossbeam 9001 through the connecting piece 2801, both sides of the connecting frame 2800 are provided with a support part in an extending manner respectively, and the support part is connected with the first support frame 210 through bolts, so as to stably fix the power transmission busbar clamping mechanism on the crossbeam 9001 to facilitate subsequent clamping operation on the power transmission busbar by the power transmission busbar clamping mechanism.

In the present embodiment, the number of the connecting frames 2800 is two, and the two connecting frames 2800 are fixedly connected with the corresponding first support plates 211 by bolts respectively, so as to ensure that the power transmission busbar clamping mechanism is stably fixed on the crossbeam 9001.

In one embodiment, each power transmission busbar clamping mechanism also comprises:

Limiting components arranged on both ends of the first support frame 210 respectively, wherein the limiting components are used for limiting the direction of the opening formed by the two busbar clamping plates 220.

In one embodiment, each limiting component comprises a first limiting plate 212 arranged on the first support frame 210 and a second limiting plate 234 arranged on the first clamping arm 230, the first limiting plate 212 or the second limiting plate 234 is provided with a limiting bolt 290, and when the first driving part drives the first clamping arm 230 to rotate with the first rotating shaft 250 as an axis, the width of the opening between the busbar clamping plates 220 is effectively prevented from being too large by the withstanding action on the first limiting plate 212 or the second limiting plate 234 by the limiting bolt 290, so as to protect the power transmission vehicle device against the influence of unexpected events such as bumping caused by too large width of the busbar clamping opening of the power transmission busbar clamping mechanism in use.

In one embodiment, each busbar clamping plate 220 comprises a first clamping plate 221 and a first conducting plate 222, the second rotating shaft 260 is arranged in the middle of the first clamping plate 221, and the first clamping plate 221 rotates with the second rotating shaft 260 as an axis; and the first conducting plate 222 is fixed on the first clamping plate 221, the end of the first conducting plate 222 is provided with a first conducting block 800, the first conducting block 800 is connected with the electrode clamping mechanism 300 through a connecting cable, and when a power transmission busbar is clamped by the busbar clamping plates 220 and powered on, the first conducting block 800 transmits power delivered by the power transmission busbar to the electrode clamping mechanism 2000 through the connecting cable, and a conducting electrode is clamped by the electrode clamping mechanism 2000, so as to achieve an effect of supplying power to the conducting electrode.

Further, the first conducting plate 222 is vertically fixed on the first clamping plate 221, and the first conducting block 800 is vertically fixed on the first conducting plate 222 so that the end of the first conducting block 800 is arranged towards the electrode clamping mechanism 2000 to reduce the transmission path between the busbar clamping component 200 and the electrode clamping component 2000, thus reducing the assembly cost of the power transmission vehicle device of the present application.

### Embodiment 2

Different from conventional workpieces, a power transmission circuit of a power transmission vehicle device needs to be connected with a power transmission busbar to obtain high current during power transmission, a busbar fixture is arranged at the top of a vehicle frame to be connected with the power transmission busbar, the clamping opening of the busbar fixture is arranged upward to facilitate the clamping of the power transmission busbar, but the arrangement of the busbar fixture at the top of the base frame often greatly increases the overall installation height of the power transmission vehicle, and the installation height of the power transmission busbar will also be increased if the power transmission vehicle with the busbar fixture arranged at the top of the base frame is placed in a work site. The adaptive installation of the power transmission busbar cannot be completed or the installation difficulty of the power transmission busbar is increased in the presence of a height limit in the installation site of an Acheson graphitization furnace, and the power transmission vehicle with the busbar fixture arranged at the top of the base frame cannot be used effectively. In this way, the present embodiment can also adopt the following structure to solve the problem that the adaptive installation of the power transmission busbar cannot be completed or the installation difficulty of the power transmission busbar is increased in the presence of a height limit in the installation site of the Acheson graphitization furnace.

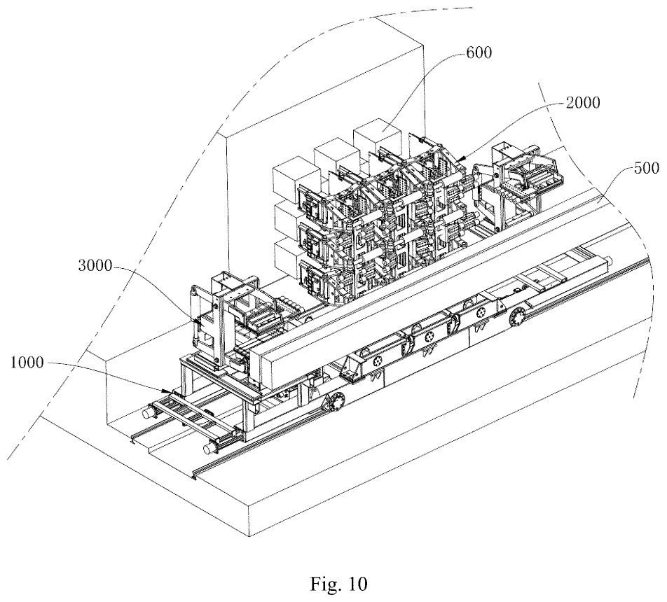

Referring to FIG. 10 to FIG. 17, the electrode clamping opening of the electrode clamping component 300 is arranged on one side of the electrode clamping mechanism 2000, the busbar clamping opening of the busbar clamping component 200 is arranged by protruding from the other side of the electrode clamping mechanism 2000 to facilitate the clamping of the power transmission busbar 500, and the power delivered by the power transmission busbar 500 is transmitted to the electrode clamping mechanism 2000, which can effectively reduce the overall height of the power transmission vehicle device, so as to avoid the problem that the overall height of the improved power transmission vehicle device is greater than that of the existing power transmission vehicle device to meet the requirement that the installation site of the Acheson graphitization furnace has a height limit; in addition, the overall height of the power transmission vehicle device is reduced to effectively avoid the problem that the overall center of gravity of the power transmission vehicle device is too high, thus ensuring the operation stability of the power transmission vehicle device; and further, the installation position of the power transmission busbar 500 must adapt to the position of the busbar clamping opening of the busbar clamping component 200, so as to effectively reduce the installation height and the installation difficulty of the power transmission busbar 500, and the arrangement that the installation position of the power transmission busbar 500 is matched with the busbar clamping opening can also ensure that the distance between the power transmission busbar 500 and the conducting electrode 600 is increased, which avoids unnecessary damage caused by mutual influence between the power transmission busbar 500 and the conducting electrode 600 during operation, wherein the specific structure that the busbar clamping opening of the busbar clamping component 200 is arranged by protruding from the other side of the electrode clamping mechanism 2000 can be that the busbar clamping opening part of the busbar clamping component 200 is arranged by completely protruding from the other side of the electrode clamping mechanism 2000 or the busbar clamping opening part of the busbar clamping component 200 is arranged by partially protruding from the other side of the electrode clamping mechanism 2000.

In one embodiment, the electrode clamping opening of the electrode clamping component 300 is arranged on one side of the electrode clamping mechanism 2000, and the busbar clamping opening of the busbar clamping component 200 is arranged by protruding from the other side of the electrode clamping mechanism 2000. The present embodiment specifically adopts a method for limiting the installation height of the upper end of the power transmission busbar clamping mechanism 3000 in the presence of a height limit in the installation site of the Acheson graphitization furnace, i.e., the height of the upper end of the power transmission busbar clamping mechanism 3000 is not greater than that of the upper end of the electrode clamping mechanism 2000, which can effectively reduce the overall height of the power transmission vehicle device; in addition, with the reduction of the installation height of the upper end of the power transmission busbar clamping mechanism 3000, to ensure the stability of connection between the power transmission busbar 500 and the power transmission busbar clamping mechanism 3000, the present embodiment also reduces the installation height of the power transmission busbar 500 compared with the existing method for placing the power transmission busbar 500 above the power transmission vehicle device, so as to reduce the installation difficulty of the power transmission busbar 500; and further, the overall height of the power transmission vehicle device is reduced to avoid the problem that the overall center of gravity of the power transmission vehicle device is too high due to that the installation height of the upper end of the power transmission busbar clamping mechanism 3000 is greater than that of the electrode clamping mechanism 2000, thus ensuring the operation stability of the power transmission vehicle device.

Alternatively, the electrode clamping opening of the electrode clamping component 300 is arranged on one side of the electrode clamping mechanism 2000, and the busbar clamping opening of the busbar clamping component 200 is arranged by protruding from the other side of the electrode clamping mechanism 2000. The present embodiment specifically adopts a method for limiting the installation height of the upper end of the power transmission busbar clamping mechanism 3000 in the presence of a height limit in the installation site of the Acheson graphitization furnace, i.e., the height of the upper end of the power transmission busbar clamping mechanism 3000 can be set to greater than a preset value of the height of the upper end of the electrode clamping mechanism 2000, which can effectively reduce the overall height of the power transmission vehicle device, and can effectively reduce the installation difficulty of the power transmission busbar 500 in the presence of a height limit in the installation site of the Acheson graphitization furnace; and further, the overall height of the power transmission vehicle device is reduced to avoid the problem that the overall center of gravity of the power transmission vehicle device is too high, thus ensuring the operation stability of the power transmission vehicle device.

The preset value is less than ½ of the height value of the busbar clamping component 200 and can be set to another height value as required, so as to achieve an installation effect of the power transmission vehicle device in the presence of a height limit in the installation site of the Acheson graphitization furnace and synchronously realize stable installation of the power transmission busbar 500, thus ensuring that the power transmission busbar 500 is clamped by the busbar clamping component 200; specifically, if the busbar clamping opening of the busbar clamping component 200 is arranged towards one side away from the electrode clamping mechanism 2000, i.e., the busbar clamping opening of the busbar clamping component 200 is horizontally arranged, the preset value is set to less than half of the horizontal height of the busbar clamping component 200, which also ensures the reduction of the overall height of the power transmission vehicle device to meet the condition that the installation site of the Acheson graphitization furnace has a height limit; and if the busbar clamping opening of the busbar clamping component 200 is arranged towards the top of the installation site, i.e., the busbar clamping opening of the busbar clamping component 200 is arranged upward, the preset value is set to less than half of the vertical height of the busbar clamping component 200, which also ensures the reduction of the overall height of the power transmission vehicle device to meet the condition that the installation site of the Acheson graphitization furnace has a height limit.

In one embodiment, each power transmission busbar clamping mechanism 3000 also comprises a first fixing seat 301, the busbar clamping component 200 is arranged on the first fixing seat 301, the first fixing seat 301 is arranged on both ends of the vehicle body 1000, the electrode clamping mechanism 2000 is arranged between two first fixing seats 301, and the power transmission busbar 500 is clamped by two busbar clamping components 200, which effectively ensures the stability of connection between the power transmission busbar clamping mechanism 3000 and the power transmission busbar 500 and more stably realize transmitting the power delivered from the power transmission busbar 500 to the conducting electrode 600 through the electrode clamping mechanism 2000.

In one embodiment, if the busbar clamping opening of the busbar clamping component 200 is arranged towards one side away from the electrode clamping mechanism 2000, i.e., the busbar clamping opening of the busbar clamping component 200 is horizontally arranged, and the busbar clamping opening of the busbar clamping component 200 faces opposite to the electrode clamping opening of the electrode clamping component 300; in addition, since the busbar clamping opening of the busbar clamping component 200 faces opposite to the electrode clamping opening of the electrode clamping component 300, and the power transmission busbar 500 is installed on the other side of the electrode clamping mechanism 2000, it is only necessary to limit the installation height of the upper end of the busbar clamping component 200, i.e., the height of the upper end of the busbar clamping component 200 is not greater than that of the upper end of the electrode clamping mechanism 2000, or the height of the upper end of the busbar clamping component 200 is not greater than a preset value of the height of the upper end of the electrode clamping mechanism 2000, which can avoid the design structure that the installation height of the busbar clamping component 200 is greater than that of the strut 100 due to the upward busbar clamping opening of an existing busbar clamping component 200, so as to avoid the problem that the overall center of gravity of the power transmission vehicle device is too high, thus ensuring the operation stability of the power transmission vehicle device.

The first fixing seat 301 is provided with a sliding rail 3011, the sliding rail 3011 is horizontally arranged, the sliding rail 3011 is provided with a bracket 3012, the busbar clamping component 200 is arranged on the bracket 3012, and the bracket 3012 is slid back and forth along the direction of the sliding rail 3011, so as to drive the busbar clamping component 200 to slide back and forth along the direction of the sliding rail 3011, thus limiting the overall width of the power transmission vehicle device during movement; when it is not necessary to clamp the power transmission busbar 500 by the busbar clamping component 200, the busbar clamping component 200 is moved away from the power transmission busbar 500 by movement of the bracket 3012 along the sliding rail 3011 towards one side with the electrode clamping opening of the electrode clamping component 300, which protects the power transmission vehicle device against the influence of the power transmission busbar 500 during movement; in addition, the busbar clamping component 200 is retracted into the integral structure of the power transmission vehicle device by movement of the bracket 3012 along the sliding rail 3011 towards one side with the electrode clamping opening of the electrode clamping component 300, and the overall width of the power transmission vehicle device is also reduced, which, on one hand, reduces the volume of the assembled power transmission vehicle device to facilitate the transportation of the power transmission vehicle device, and on the other hand, ensures that the operation of the power transmission vehicle device in use will not be affected by the power transmission busbar 500; and in the present embodiment, the bracket 3012 can be moved back and forth along the direction of the sliding rail 3011 by means of arranging a driving mechanism to drive a driving rod or by means of arranging a driving mechanism to drive a lead screw, which is the known technology and will not be repeated herein.

Further, both sides of the bottom end of the bracket 3012 are provided with a sliding block 3013 respectively; and the sliding blocks 3013 are stuck in the sliding rail 3011; and specifically, the sliding rail 3011 is provided with a dovetail groove 3014, and the sliding blocks 3013 are stuck in the dovetail groove 3014, so as to improve the stability of movement of the bracket 3012 along the direction of the sliding rail 3011.

Further, the installation height of the upper end of the busbar clamping component 200 depends on the installation height of the upper end of the bracket 3012, so the overall height of the power transmission vehicle device can be effectively reduced by ensuring that the height of the upper end of the bracket 3012 is not greater than that of the upper end of the electrode clamping mechanism 2000 or the height of the upper end of the bracket 3012 is not greater than a preset value of the height of the upper end of the electrode clamping mechanism 2000, which can effectively reduce the overall height of the power transmission vehicle device, thus avoiding the problem that the overall height of the improved power transmission vehicle device is greater than that of the existing power transmission vehicle device to meet the requirement that the installation site of the Acheson graphitization furnace has a height limit; and in addition, the overall height of the power transmission vehicle device is reduced to effectively avoid the problem that the overall center of gravity of the power transmission vehicle device is too high, thus ensuring the operation stability of the power transmission vehicle device.

Referring to FIG. 15 and FIG. 16, alternatively, each power transmission busbar clamping mechanism 3000 also comprises a second fixing seat 302, the busbar clamping component 200 is arranged on the second fixing seat 302, the second fixing seat 302 is arranged on both ends of the vehicle body 1000, the electrode clamping mechanism 2000 is arranged between two second fixing seats 302, and the power transmission busbar 500 is clamped by two busbar clamping components 200, which effectively ensures the stability of connection between the power transmission busbar clamping mechanism 3000 and the power transmission busbar 500 and more stably realizes transmitting the power delivered from the power transmission busbar 500 to the conducting electrode 600 through the electrode clamping mechanism 2000.

In one embodiment, if the busbar clamping opening of the busbar clamping component 200 is arranged towards the top of the installation site, i.e., the busbar clamping opening of the busbar clamping component 200 is arranged upward, the power transmission busbar 500 is installed on the other side of the electrode clamping mechanism 2000, it is only necessary to limit the installation height of the upper end of the busbar clamping component 200, i.e., the height of the upper end of the busbar clamping component 200 is not greater than that of the upper end of the electrode clamping mechanism 2000, or the height of the upper end of the busbar clamping component 200 is not greater than a preset value of the height of the upper end of the electrode clamping mechanism 2000, which can effectively reduce the overall height of the power transmission vehicle device, thus avoiding the problem that the overall height of the improved power transmission vehicle device is greater than that of the existing power transmission vehicle device to meet the requirement that the installation site of the Acheson graphitization furnace has a height limit; and in addition, the overall height of the power transmission vehicle device is reduced to effectively avoid the problem that the overall center of gravity of the power transmission vehicle device is too high, thus ensuring the operation stability of the power transmission vehicle device.

The second fixing seat 302 comprises two fixing frames 303, each fixing frame 303 is provided with a sliding rail 3011, the sliding rail 3011 is vertically arranged, the sliding rail 3011 is provided with a bracket 3012, the busbar clamping component 200 is arranged on the bracket 3012, and the bracket 3012 is slid back and forth along the direction of the sliding rail 3011, so as to drive the busbar clamping component 200 to slide back and forth along the direction of the sliding rail 3011, thus limiting the overall center of gravity of the power transmission vehicle device to ensure the stability of the power transmission vehicle device during movement; when it is not necessary to clamp the power transmission busbar 500 by the busbar clamping component 200, the busbar clamping component 200 is moved away from the power transmission busbar 500 by downward movement of the bracket 3012 along the sliding rail 3011, which protects the power transmission vehicle device against the influence of the power transmission busbar 500 during movement; when it is necessary to clamp the power transmission busbar 500 by the busbar clamping component 200, the busbar clamping component 200 is moved close to the power transmission busbar 500 by upward movement of the bracket 3012 along the sliding rail 3011, and the clamping operation of the power transmission busbar 500 is completed; and in the present embodiment, the bracket 3012 can be moved up and down along the direction of the sliding rail 3011 by means of arranging a driving mechanism to drive a driving rod or by means of arranging a driving mechanism to drive a lead screw; which is the known technology and will not be repeated herein.

Further, both ends of the bracket 3012 are provided with a sliding block 3013 respectively, and the sliding blocks 3013 are stuck in the sliding rail 3011; specifically, the sliding rail 3011 is provided with a dovetail groove, and the sliding blocks 3013 are stuck in the dovetail groove, so as to improve the stability of movement of the bracket 3012 along the direction of the sliding rail 3011; and in addition, the sliding blocks 3013 are arranged on both ends of the bracket 3012 respectively and stuck on the sliding rail 3011 so as to improve the stability of movement between two fixing frames 303 so that the busbar clamping component 200 can be stably moved upward or downward along the direction of the sliding rail 3011.

In one embodiment, the busbar clamping component 200 comprises:
A first support frame 210,
Two busbar clamping plates 220 arranged oppositely, wherein the two busbar clamping plates 220 realize clamping operation of a power transmission busbar on a furnace body together; and in the present embodiment, the busbar clamping opening is surrounded by the two busbar clamping plates 220, and the two busbar clamping plates 220 are arranged in forward and backward directions;
Two first clamping arms 230, which are hinged with both sides of the first support frame 210 respectively, wherein the two busbar clamping plates 220 are arranged on the two first clamping arms 230 respectively; the first clamping arms 230 are arranged near the two limiting baffle plates 9002 to limit the width of the busbar clamping opening of the busbar clamping component 200, which, on one hand. reduces the volume of the assembled busbar clamping component 200 to facilitate transporting the power transmission vehicle device to different places, and on the other hand, protects the busbar clamping component 200 through the limiting baffle plates 9002 to protect the power transmission vehicle device against the influence of unexpected events such as bumping caused by too large width of the busbar clamping opening of the busbar clamping component 200 in use; and
A first driving part 240, which is arranged between the two first clamping arms 230 and connected with the two first clamping arms 230 respectively.

Both sides of the first support frame 210 are hinged with the middle parts of the two first clamping arms 230 respectively to form two supporting points, and the first clamping arms 230 and the first support frame 210 are all sheet plates in a long strip shape; and both ends of the first driving part 240 are hinged on first ends of the two first clamping arms 230 respectively, and the first ends of the two first clamping arms 230 can be driven by the first driving part 240 to open and close around the supporting points, so as to drive the two busbar clamping plates 220 to be close to or away from each other, thus realizing clamping or loosening operation on the power transmission busbar. The first driving part 240 is a hydraulic cylinder in the present embodiment, and of course, can be a lead screw or a pneumatic cylinder in other embodiments, which will not be repeated herein.

In one embodiment, each first clamping arm 230 is provided with a first elastomer 280, the first elastomer 280 has a shrapnel structure, a first limiting part 271 is extended from the first elastomer 280 in a bending manner, the first limiting part 271 is abutted against one side of the busbar clamping plate 220. and the first limiting part 271 is used for limiting the initial installation angle of the busbar clamping plate 220, so as to adapt to the width setting of the power transmission busbar.

In one embodiment, the first limiting parts 271 of at least two first elastomers 280 are arranged on both sides of the first rotating shaft 250 respectively, so as to ensure that the busbar clamping plate 220 is withstood by the first limiting part 271 on the corresponding side when rotating forwards or backwards with the first rotating shaft 250 as an axis, thus ensuring that the opening corresponding to the initial installation angle of the busbar clamping plate 220 on the first clamping arm 230 is suitable for the width of the power transmission busbar, and before the power transmission busbar is clamped by the busbar clamping plates 220, the width of the opening between the busbar clamping plates 220 can adapt to the size of the power transmission busbar; and when the power transmission busbar is clamped by the busbar clamping plates 220, the busbar clamping plates 220 can form a stable fit relationship with the power transmission busbar to ensure the contact area of the busbar clamping plates 220 and the power transmission busbar.

In one embodiment, each first clamping arm 230 is provided with a first fixing plate 233, the first elastomers 280 are arranged on the first fixing plate 233 at intervals, the first limiting parts 271 located on both sides of the first fixing plate 233 are also arranged on both sides of the first rotating shaft 250 respectively, so as to ensure that the busbar clamping plate 220 is withstood by the first limiting part 271 on the corresponding side when rotating forwards or backwards with the first rotating shaft 250 as an axis, thus ensuring that the opening corresponding to the initial installation angle of the busbar clamping plate 220 on the first clamping arm 230 is suitable for the width of the power transmission busbar, and before the power transmission busbar is clamped by the busbar clamping plates 220, the width of the opening between the busbar clamping plates 220 can adapt to the size of the power transmission busbar; and when the power transmission busbar is clamped by the busbar clamping plates 220, the busbar clamping plates 220 can form a stable fit relationship with the power transmission busbar to ensure the contact area of the busbar clamping plates 220 and the power transmission busbar.

In other embodiments, the first elastomers 280 are arranged on the first clamping arms 230 to match both ends of the busbar clamping plate 220 to limit both ends of the busbar clamping plate 220 respectively, so as to limit the initial installation angle of the busbar clamping plate 220, thus meeting the width requirement of the power transmission busbar.

In one embodiment, the first fixing plate 233 is provided with fixing holes, one end of each first elastomer 280 is fixed on the first fixing plate 233 through screws, and the screws pass through one end of the first elastomer 280 and are stuck in the fixing holes.

In one embodiment, the first limiting part 271 is provided with screw holes, a first adjusting bolt is arranged in each screw hole, the first adjusting bolt is stuck in the screw hole, one end of the first adjusting bolt is abutted against one side of the busbar clamping plate 220, and the initial installation angle of the busbar clamping plate 220 is adjusted by adjusting the length of one end of the first adjusting bolt extending from the screw hole, so as to adapt to power transmission busbars of different sizes.

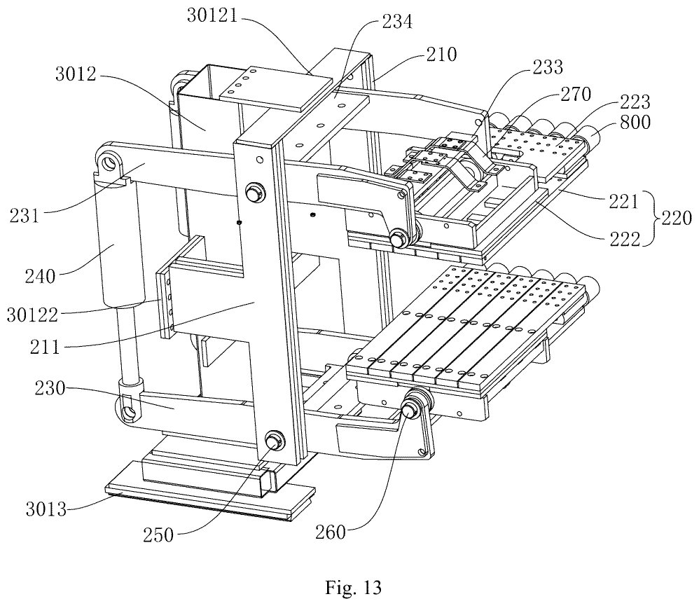

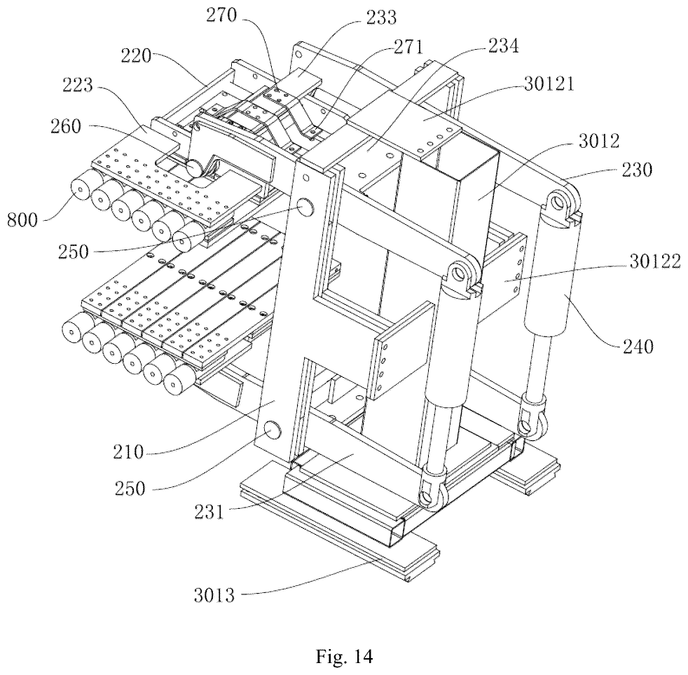

Referring to FIG. 13 and FIG. 14, in the present embodiment, each first clamping arm 230 comprises two first gripper arms 231 and a first limiting plate 212 fixedly connected between the two first gripper arms 231, the first limiting plate 212 is used for connecting the two first gripper arms 231 into a whole, each first clamping arm 230 has a framework structure, and the two first clamping arms 230 are symmetrically arranged.

The first support frame 210 is provided with two first support plates 211 arranged in parallel, both ends of each first support plate 211 are pivoted to the first gripper arm 231 on the corresponding side through the first rotating shaft 250, and the first rotating shaft 250 forms the supporting point as described above;

The number of the first driving parts 240 is two, the two first driving parts 240 are arranged in parallel, and both ends of each first driving part 240 are hinged with a first end of the first gripper arm 231 on the same side respectively; and the two first driving parts 240 are operated synchronously.

Each first clamping plate 221 is pivoted to the end of the first gripper arm 231 on the same side through the second rotating shaft 260 and can swing around the second rotating shaft 260.

When the first driving part 240 drives the first clamping arms 230 to approach each other, the busbar clamping plates 220 on the first clamping arms 230 will gradually approach the power transmission busbar, and the busbar clamping plates 220 will rotate with the second rotating shaft 260 as an axis for self-adjustment according to actual needs to ensure close fit with the power transmission busbar, so as to maximize the contact area of the busbar clamping plate 220 and the power transmission busbar, thus increasing the electrical conduction efficiency.

In one embodiment, the busbar clamping plate 220 comprises a first clamping plate 221 and a first conducting plate 222, the second rotating shaft 260 is arranged in the middle of the first conducting plate 222, and the first conducting plate 222 rotates with the second rotating shaft 260 as an axis; the first conducting plate 222 is fixed on the first clamping plate 221 and extended to the outer side of the first clamping plate 221, and specifically, the first conducting plate 222 is fixed on the first clamping plate 221 and extended towards one side of the electrode clamping component 300 to the outer side of the first clamping plate 221, so as to reduce the transmission path between the power transmission busbar clamping mechanism 3000 and the electrode clamping mechanism 2000, thus reducing the assembly cost of the power transmission vehicle device of the present application; the first clamping plate 221 is provided with a connecting plate 223 towards one side of the electrode clamping component 300, the connecting plate 223 is provided with a first conducting block 800, one end of the first conducting block 800 is connected with the first conducting plate 222, and the other end of the first conducting block 800 is connected with the electrode clamping mechanism 2000 through a connecting cable; and when the power transmission busbar 500 is clamped by the busbar clamping plates 220 and powered on, the power delivered by the power transmission busbar 500 is transmitted to the electrode clamping component 300 through the first conducting block 800, and a conducting electrode 600 is clamped by the electrode clamping component 300, so as to achieve an effect of supplying power to the conducting electrode 600.

Referring to FIG. 13 and FIG. 14, in one embodiment, the upper end of the bracket 3012 is provided with a first T-shaped bracket plate 30121, and the first support plates 211 are fixedly arranged on both sides of the first bracket plate 30121; and both sides of the bracket 3012 are also provided with a second bracket plate 30122 respectively, the second bracket plate 30122 is connected with the middle parts of the first support plates 211, and the second bracket plate 30122 is matched with the first bracket plate 30121 to jointly achieve a stable support effect of the first support plates 211.

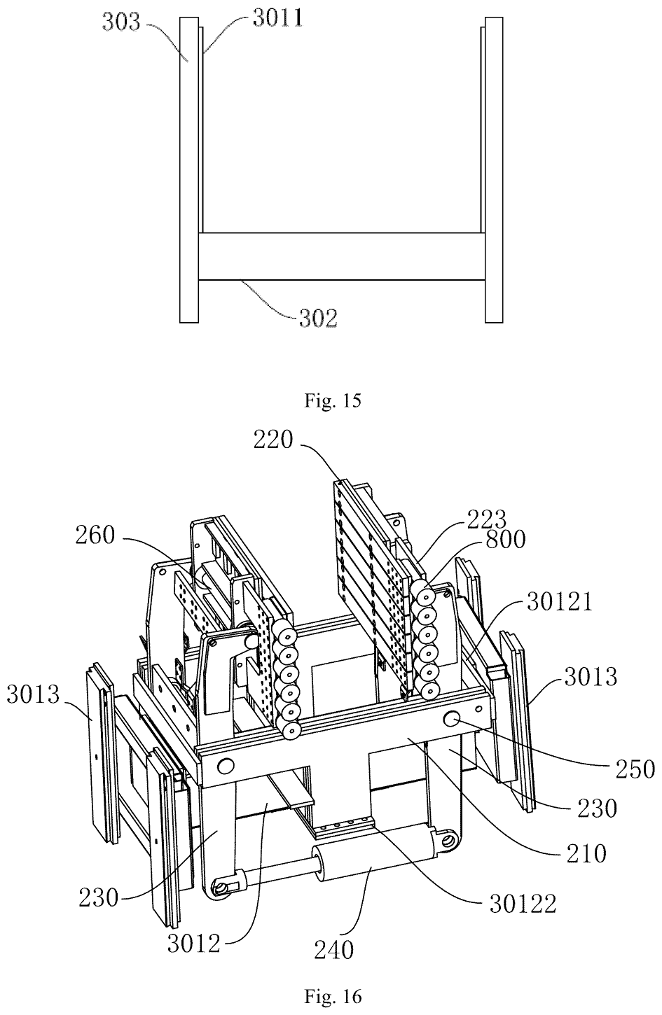

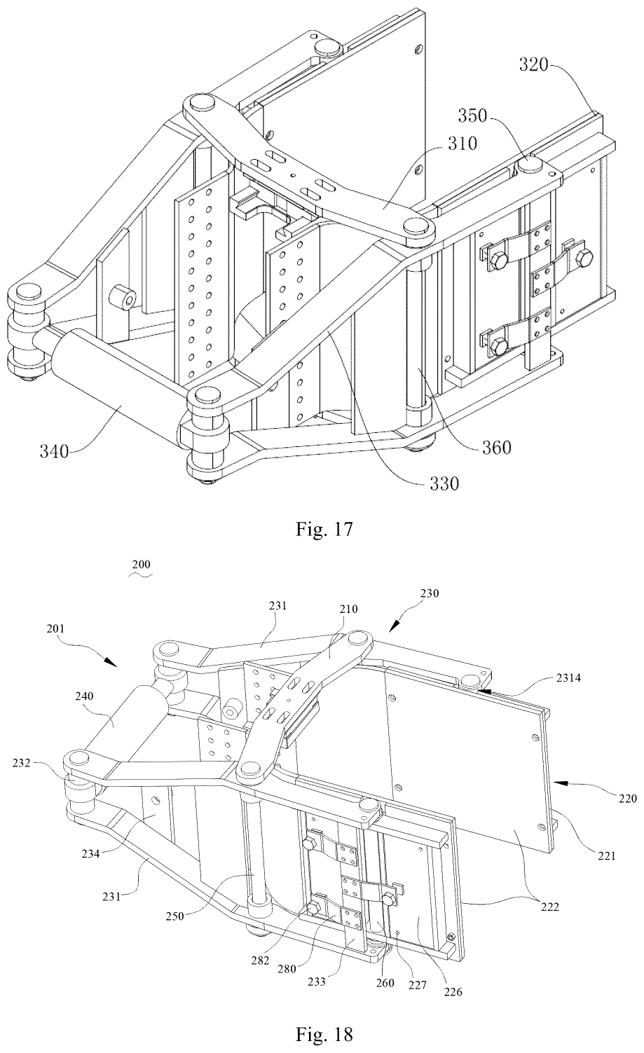

Referring to FIG. 17, the electrode clamping component 300 comprises:
A second support frame 310, which is arranged on the strut 100;
Two electrode clamping plates 320 arranged oppositely, wherein the two electrode clamping plates 320 realize clamping operation of a conducting electrode on a furnace body together; and in the present embodiment, the electrode clamping opening is surrounded by the two electrode clamping plates 320, the two electrode clamping plates 320 are arranged in left and right directions, and the electrode clamping opening has a longitudinal structure to facilitate the matching of the longitudinal installation characteristics of the conducting electrode 600;
Two second clamping arms 330, which are hinged with both sides of the second support frame 310 respectively, wherein the two electrode clamping plates 320 are arranged on the two second clamping arms 330 respectively; and
A second driving part 340, which is arranged between the two second clamping arms 330 and connected with the two second clamping arms 330 respectively.

Both sides of the second support frame 310 are hinged with the middle parts of the two second clamping arms 330 respectively to form two supporting points, and the second clamping arms 330 and the second support frame 310 are all sheet plates in a long strip shape; and both ends of the second driving part 340 are hinged on second ends of the two second clamping arms 330 respectively, and the second ends of the two second clamping arms 330 can be driven by the second driving part 340 to open and close around the supporting points, so as to drive the two electrode clamping plates 320 to be close to or away from each other, thus realizing clamping or loosening operation on the conducting electrode. The second driving part 340 is a hydraulic cylinder in the present embodiment, and of course, can be a lead screw or a pneumatic cylinder in other embodiments, which will not be repeated herein.

Both sides of the second support frame 310 are hinged with the second clamping arm 330 on the corresponding side respectively through a third rotating shaft 350, and the second rotating shaft 260 forms the supporting point as described above.

Each electrode clamping plate 320 is hinged on the end of the second clamping arm 330 on the corresponding side through a fourth rotating shaft 360, and the electrode clamping plate 320 can be arranged in a mode of swinging around the fourth rotating shaft 360; and specifically, when the second driving part 340 drives the second clamping arms 330 approach each other, the electrode clamping plates 320 on the second clamping arms 330 will gradually approach the conducting electrode, and the electrode clamping plates 320 will rotate with the fourth rotating shaft 360 as an axis for self-adjustment according to actual needs to ensure close fit with the conducting electrode, so as to maximize the contact area of the electrode clamping plates 320 and the conducting electrode, thus increasing the electrical conduction efficiency.

In one embodiment, the vehicle body 1000 is provided with a sliding mechanism 400, and the electrode clamping mechanism 2000 is arranged on the sliding mechanism 400; and specifically, the sliding mechanism 400 comprises a support frame body 410, at least one support shaft 420, a moving mechanism 430 and a driving mechanism 440. A moving space suitable for the electrode clamping mechanism 2000 is formed in the support frame body 410. At least one support shaft 420 is located in the moving space and connected with the support frame body 410. The moving mechanism 430 is located in the moving space and can move relative to the support shaft 420, and the moving mechanism 430 is configured to support and connect the electrode clamping mechanism 2000. The driving mechanism 440 is arranged on the support frame body 410 and is in driving connection with the moving mechanism 430, and the driving mechanism 440 is configured to drive the moving mechanism 430 to drive the electrode clamping mechanism 2000 to move along the axial direction of the support shaft 420, so as to drive the electrode clamping mechanism 2000 to clamp a conducting electrode. Further, the strut 100 is arranged on the moving mechanism 430 and moved back and forth along with the moving mechanism 430 along the axial direction of the support shaft 420.

In specific use of the present embodiment, the power transmission vehicle device is located on a running rail between the conducting electrode 600 and the power transmission busbar 500, in order to prevent the busbar clamping component 200 from coming in contact with the power transmission busbar 500 when the power transmission vehicle device moves along the running rail, the busbar clamping component 200 is moved for a certain distance towards the direction away from the power transmission busbar 500 by driving the bracket 3012 to slide along the direction of the sliding rail 3011; after the power transmission vehicle device moves to a preset position along the running rail, the electrode clamping component 300 is driven to clamp the conducting electrode 600, then the bracket 3012 is driven to slide along the direction of the sliding rail 3011 so that the busbar clamping component 200 is moved for a certain distance towards the direction close to the power transmission busbar 500, at this moment, the power transmission busbar 500 is located between the two busbar clamping plates 220, and finally, the first clamping arms 230 and the second clamping arms 330 are driven by the first driving part 240 to approach each other, so as to drive the two busbar clamping plates 220 to approach each other to realize clamping operation on the power transmission busbar 500 by the busbar clamping component 200, thus achieving the purpose of transmitting the power delivered by the power transmission busbar 500 to the electrode clamping mechanism 2000; since the busbar clamping opening of the busbar clamping component 200 faces opposite to the electrode clamping opening of the electrode clamping component 300, it is only necessary to limit the installation height of the upper end of the busbar clamping component 200, and the height of the upper end of the power transmission busbar clamping mechanism 3000 is designed to not greater than that of the upper end of the electrode clamping mechanism 2000, or the height of the upper end of the power transmission busbar clamping mechanism 3000 is designed to greater than a preset value of the height of the upper end of the electrode clamping mechanism 2000, which, compared with the design problem that the installation height of the busbar clamping component 200 is much greater than that of the electrode clamping mechanism 2000 due to the upward busbar clamping opening of an existing busbar clamping component 200, can reduce the overall height of the power transmission vehicle by reducing the installation height of the busbar clamping component 200 on the premise that the height of an existing electrode clamping mechanism 2000 remains unchanged, so as to meet the requirement that the installation site of the Acheson graphitization furnace has a height limit; in addition, the overall height of the power transmission vehicle device is reduced to avoid the problem that the overall center of gravity of the power transmission vehicle device is too high, thus ensuring the operation stability of the power transmission vehicle; and moreover, the busbar clamping component 200 is driven to move along the direction of the sliding rail 3011 by movement of the bracket 3012 along the direction of the sliding rail 3011 so that the busbar clamping component 200 is retracted into the integral structure of the power transmission vehicle device, and the overall width of the power transmission vehicle device is reduced, which is easier to facilitate transportation operation after the overall assembly of the power transmission vehicle.

### Embodiment 3

Different from conventional workpieces, the power transmission busbar will produce more heat during operation and transmit the heat to the busbar clamping plates of the busbar clamping component 200 directly connected therewith, and the busbar clamping plates will deform when heated, which will result in poor contact between the busbar clamping plates and the power transmission busbar and affect the effect of stable power transmission. In addition, if the busbar clamping plates are in a high temperature state for a long time, the aging thereof will be accelerated. In this way, the present embodiment specifically adopts the following structure to solve the problems of poor contact and rapid aging caused by the busbar clamping plates in a high temperature state for a long time.

Referring to FIG. 18 to FIG. 21, the electrode clamping component 300 comprises:
Electrode clamping plates 320, which are used for clamping a conducting electrode on the furnace body;
A first clamping component 201, which is used for driving the electrode clamping plates 320 to be close to or away from each other.

Each electrode clamping plate 320 comprises a first clamping plate 221 and a first conducting plate 222. The first clamping plate 221 has an overall shape of rectangle and a size matched with the conducting electrode, and it can be understood that the first clamping plate 221 can also be set to a circle, an oval or another geometrical shape, and relatively speaking, is easier to manufacture in a rectangle. The back surface of the first clamping plate 221 is provided with a cooling pipeline, the cooling pipeline is provided with connectors for connecting circulating fluid, and at least two connectors are arranged: one in and one out. The first conducting plate 222 is arranged closely to the front surface of the first clamping plate 221, the first conducting plate 222 is in direct contact with the conducting electrode and is connected with the electrode clamping mechanism 2000 through a connecting cable to transmit power delivered by the power transmission busbar to the first conducting plate 222, and then the first conducting plate 222 transmits the power to the conducting electrode, thus realizing the operation of power supply to the Acheson graphitization furnaces.

During operation, the first conducting plate 222 is heated by direct contact with the conducting electrode, the cooling pipeline is connected to external circulating fluid through the connectors on both ends and filled with circulating cooling water, which can take away the heat of the first conducting plate 222 to cool the first conducting plate 222, so as to reduce adverse effects such as deformation and aging caused by high temperature on the first conducting plate 222; and moreover, such structure that the first conducting plate 222 and the first clamping plate 221 are assembled into the electrode clamping plate 320 is more scientific and practical than directly arranging a cooling pipeline on the first conducting plate 222, and is convenient for maintenance and replacement.

In one embodiment, the cooling pipeline is attached in an S-shape to the back surface of the first clamping plate 221, and the pipeline in such structure is distributed in the whole first clamping plate 221, which can achieve a quick and uniform cooling effect.

Specifically, the first clamping plate 221 is also provided with a protecting shell, the protecting shell comprises a side plate 225 enclosing the cooling pipeline and a cover plate 226 covering the edge of the side plate 225, and the cover plate 226 is provided with through holes 227 corresponding to the connectors. The protecting shell can play a role in protecting the cooling pipeline and prevent damage to the cooling pipeline.

In one embodiment, the cooling pipeline can be designed as a water cooling pipeline, and the circulating fluid is circulating water.

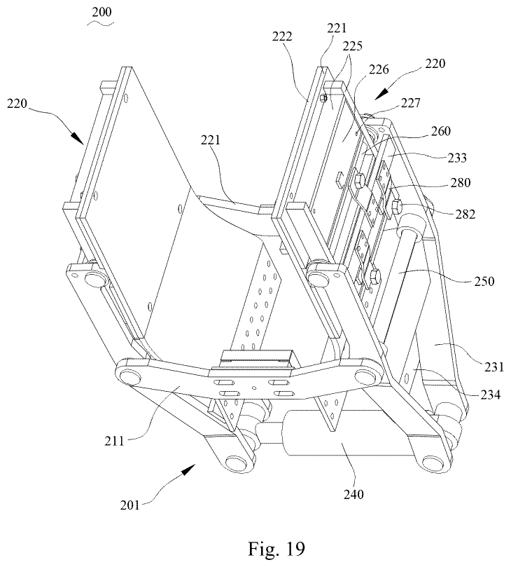

Referring to FIG. 18 and FIG. 19, the first clamping component 201 comprises:
A first support frame 210,
Two first clamping arms 230, which are hinged with both sides of the first support frame 210 respectively, wherein the electrode clamping plates 320 are arranged on the first clamping arms 230 in a matching manner; and
A first driving part 240, which is arranged between the two first clamping arms 230 and connected with the two first clamping arms 230 respectively.

Both sides of the first support frame 210 are hinged with the middle parts of the two first clamping arms 230 respectively to form two supporting points, and the first clamping arms 230 and the first support frame 210 are all sheet plates in a long strip shape; and both ends of the first driving part 240 are hinged on first ends of the two first clamping arms 230 respectively, and second ends of the two first clamping arms 230 can be driven by the first driving part 240 to open and close around the supporting points. The first driving part 240 is a hydraulic cylinder in the present embodiment, and of course, can be a lead screw or a pneumatic cylinder in other embodiments, which will not be repeated herein.

Accordingly, a pair of electrode clamping plates 320 are arranged and hinged on the corresponding first clamping arms 230 respectively, so the two electrode clamping plates 320 can swing around a pivot respectively. When the conducting electrode is clamped by the electrode clamping plates 320, the two electrode clamping plates 320 can also swing according to the deviation of the position of the conducting electrode, so as to reduce counter stress between the electrode clamping plates 320 and the conducting electrode, prevent damage to the conducting electrode and prolong the service life of the device.

During actual production of Acheson graphitization furnaces, the position of the conducting electrode cannot be absolutely ideal, and the conducting electrode will be subjected to a degree of expansive deformation due to uneven heat. If the electrode clamping plates 320 are not aligned with the position of the conducting electrode, other counter stresses will occur between the electrode clamping plates 320 and the conducting electrode besides clamping force, which is very likely to cause damage to the conducting electrode. The electrode clamping plates 320 are arranged to be hinged on the ends of the first clamping arms 230, and the two electrode clamping plates 320 can adapt to position offset and expansive deformation of the conducting electrode by swinging at a small angle, so as to eliminate excess stress between the clamping plates and the conducting electrode and prevent damage to the conducting electrode.

Referring to FIG. 18, in one embodiment, the ends of the two first clamping arms 230 are projected towards the direction of clamping to form a first convex part 2314, and the first clamping plate 221 is connected to the first convex part 2314. The combined structure will give the electrode clamping plates 320 a space for further moving inside the first clamping arms 230, which reduces mutual interference between the electrode clamping plates 320 and the first clamping arms 230 when swinging.

The first clamping component 201 in the above embodiment uses the lever principle to apply a force, i.e., each first clamping arm 230 is divided into an upper section and a lower section with the end point of the first support frame 210 as a supporting point, and the purpose of energy saving can be achieved by setting the length ratio of the upper section to the lower section. For example, in one specific embodiment, if the length ratio of the upper section to the lower section is set to 1.5:1, only one force is applied on the driving end to obtain 1.5 times the force on the clamping end, so as to achieve the purpose of reducing the pressure of the hydraulic cylinder.

Referring to FIG. 18 and FIG. 19, further, each first clamping arm 230 comprises two first gripper arms 231, and the two first gripper arms 231 are hinged at the supporting point of the first support frame 210; and one end of one first gripper arm 231 is fixed together with that of the other first gripper arm 231 through a connecting rod 232, the other end of one first gripper arm 231 is fixed together with that of the other first gripper arm 231 through a first fixing plate 233, both ends of the first driving part 240 are connected with the connecting rod 232 respectively, the first driving part 240 drives the two first gripper arms 231 to move together by driving the connecting rod 232 to move, so as to achieve an operation effect of driving the electrode clamping plates 320 to clamp or loosen the conducting electrode.

The first clamping arm 230 is provided with a first limiting plate 212 on one side near the connecting rod 232, and both ends of the first limiting plate 212 are connected with the two first gripper arms 231 respectively, so as to improve the structural stability of the first clamping arm 230.

The first support frame 210 is provided with two first support plates 211 arranged in parallel, both ends of each first support plate 211 are hinged with the first gripper arm 231 on the corresponding side through a first rotating shaft 250, and the first rotating shaft 250 forms the supporting point as described above.

Each electrode clamping plate 320 is hinged on the ends of the first gripper arms 231 on the corresponding side through a second rotating shaft 260, and can swing around the second rotating shaft 260

The operating principle of the electrode clamping plates 320 for the conducting electrodes of the furnace body is as follows:

The opening of the electrode clamping plates 320 for the conducting electrodes of the furnace body faces a horizontal side, and the electrode clamping plates are moved to the vicinity of the conducting electrode during operation. When the conducting electrode is extended into the opening, the hydraulic cylinder drives and extends synchronously, the two first clamping arms 230 swing around the first rotating shaft 250 so that the first clamping arms 230 are close to each other and finally drive the two electrode clamping plates 320 to clamp the two opposite surfaces of the conducting electrode. The first conducting plate 222 is in direct contact with the surface of the conducting electrode, and the cooling water flows in the cooling pipeline and always takes away the heat, which reduces the temperature of the first conducting plate 222, so as to avoid problems such as structural aging caused by high temperature. When loosened, the hydraulic cylinder retracts synchronously and then drives the first clamping arms 230 to open, and the electrode clamping plates 320 are detached from the conducting electrode and then reversely moved away from the conducting electrode.

Referring to FIG. 18. FIG. 20 and FIG. 21, it is necessary to adapt the structure of the electrode clamping plate 320 due to the presence of the first rotating shaft 250, specifically: the whole cooling pipeline is divided into a first pipeline and a second pipeline arranged side by side along a first direction, a first protecting shell and a second protecting shell are arranged respectively corresponding to the first pipeline and the second pipeline, and an avoidance groove 228 is arranged between the two protecting shells for the first rotating shaft 250 to pass through. Each protecting shell is provided with a cover plate 226, and the cover plate 226 is provided with two through holes 227. The two pipelines are communicated with each other by connecting the through holes 227 in the two cover plates 226 through a small tube which is arranged across the first rotating shaft 250. In this way, the presence of the first rotating shaft 250 will not affect the cooling function of the electrode clamping plates 320.

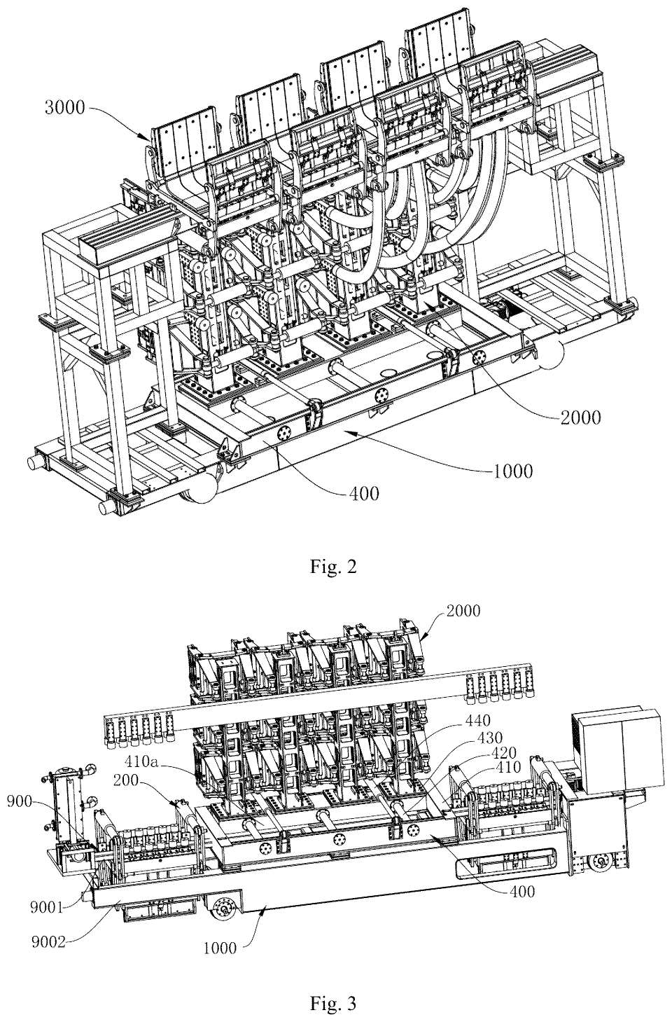

Referring to FIG. 1 and FIG. 2, the busbar clamping plates 220 for the power transmission busbar of the furnace body is to clamp a power transmission busbar located above in an operating state, so the opening is upward, and one side away from the power transmission busbar is used for connecting cables and other components.

Referring to FIG. 1 and FIG. 2, it is worth mentioning that the busbar clamping plates for the power transmission busbar of the furnace body are used on the power transmission vehicle device, and specifically, after assembly of the power transmission vehicle device, the first support frame 210 is connected to the base frame 900, so as to apply the whole busbar clamping plates on the power transmission vehicle device.

The busbar clamping plates can also be fixedly connected to the end of the first clamping arm in many modes such as welding and bolted connection. In this case, the busbar clamping plates can still achieve a cooling effect on the first conducting plate, but lacks of an adaptive effect compared with the above embodiments, and a situation that the power transmission busbar is pinched exists.

It should be noted that the conducting electrode is in a high temperature state (about 300° C.) during operation and will transmit the heat to the electrode clamping plates of the electrode clamping component 300 directly connected therewith, and the electrode clamping plates will deform when heated, which will result in poor contact between the electrode clamping plates and the conducting electrode and affect the effect of graphitization of the conducting electrode. In addition, if the electrode clamping plates are in a high temperature state for a long time, the aging thereof will be accelerated. In this way, the present embodiment specifically adopts the following cooling structure to solve the problems of poor contact and rapid aging caused by the electrode clamping plate in a high temperature state for a long time.

Since the cooling structure of the busbar clamping component 200 is consistent with the cooling structure of the electrode clamping component 300, the cooling structure applied on the busbar clamping component 200 can also be applied on the structure of the electrode clamping component 300, which will not be repeated herein.

### Embodiment 4

Different from conventional workpieces, the power transmission busbar is arranged outside a furnace, and it is necessary to clamp the power transmission busbar with the busbar clamping plates to realize electrical connection. At this moment, the busbar clamping plates are in surface contact with the power transmission busbar. During actual production, the installation position of the power transmission busbar cannot be absolutely accurate, and the vertical line of the section thereof is more or less deviated from the initial direction. Meanwhile, due to long-term use, the power transmission busbar will also be subjected to bending deformation, which results in a gap between the power transmission busbar and the busbar clamping plates which cannot be fitted closely, leading to a poor conducting effect and then affecting the quality of products manufactured by the Acheson graphitization furnace. In this way, the present embodiment specifically adopts the following structure to solve the problem of poor conducting effect due to inability to closely fit the busbar clamping plates and the power transmission busbar.

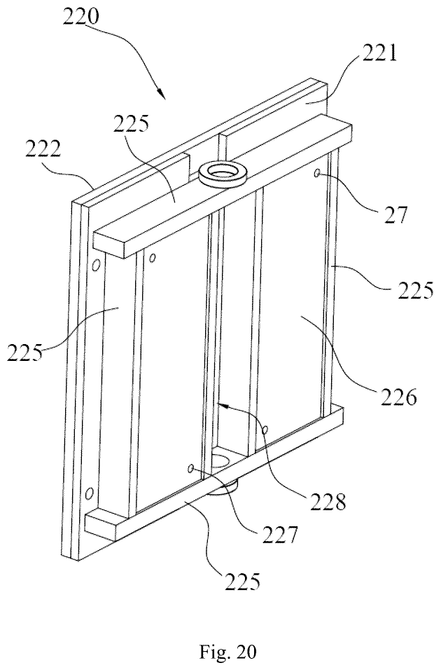

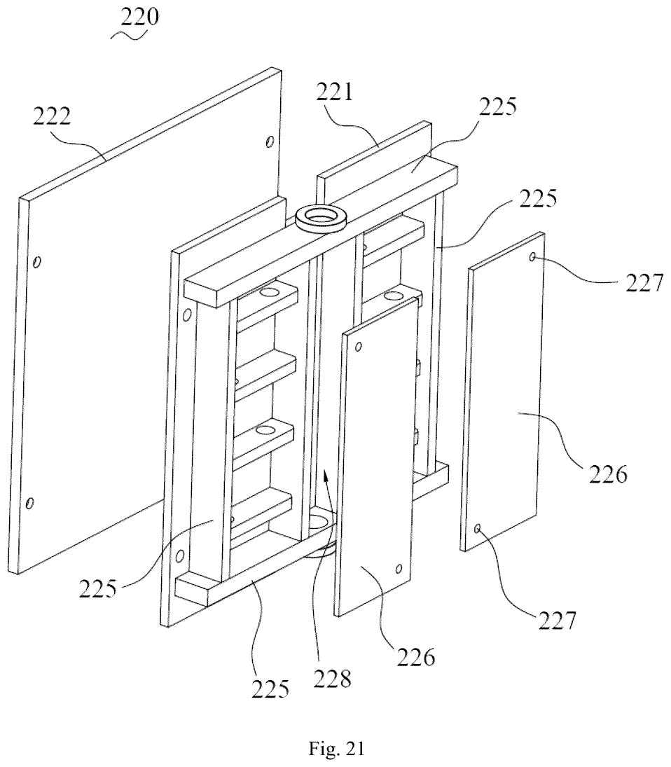

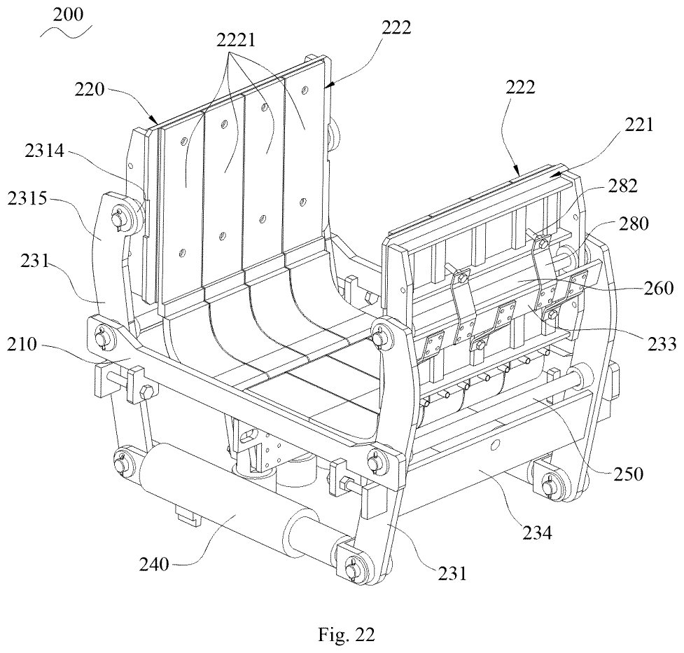

Referring to FIG. 22 to FIG. 30, in the present embodiment, the busbar clamping component 200 has a clamp-style structure using the lever principle, and the busbar clamping component 200 comprises:
Busbar clamping plates 220, which are used for clamping a power transmission busbar outside the furnace body;
A first clamping component 201, which is used for driving the busbar clamping plates 220 to be close to or away from each other.

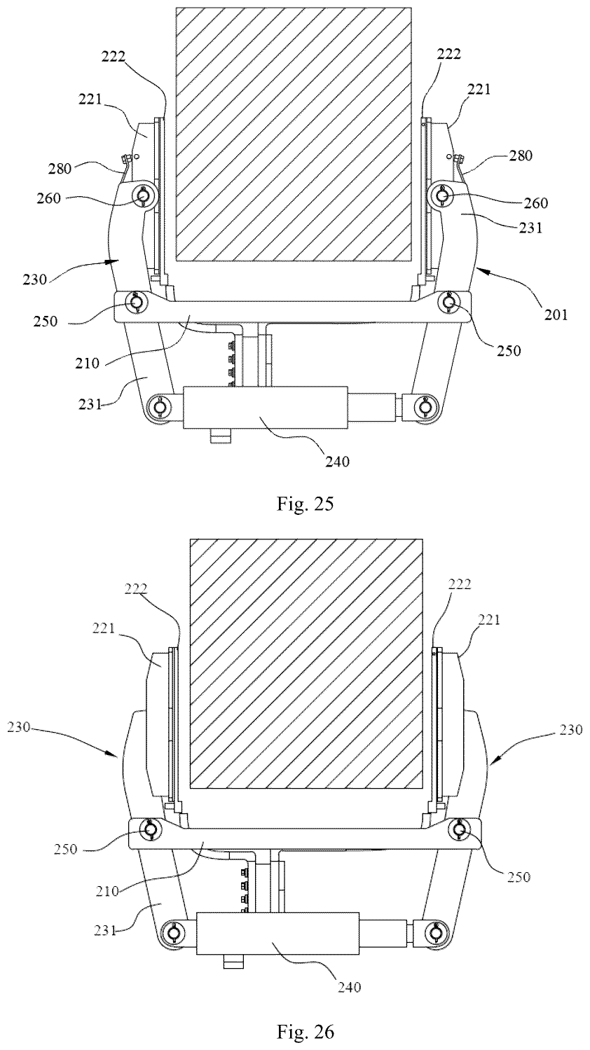

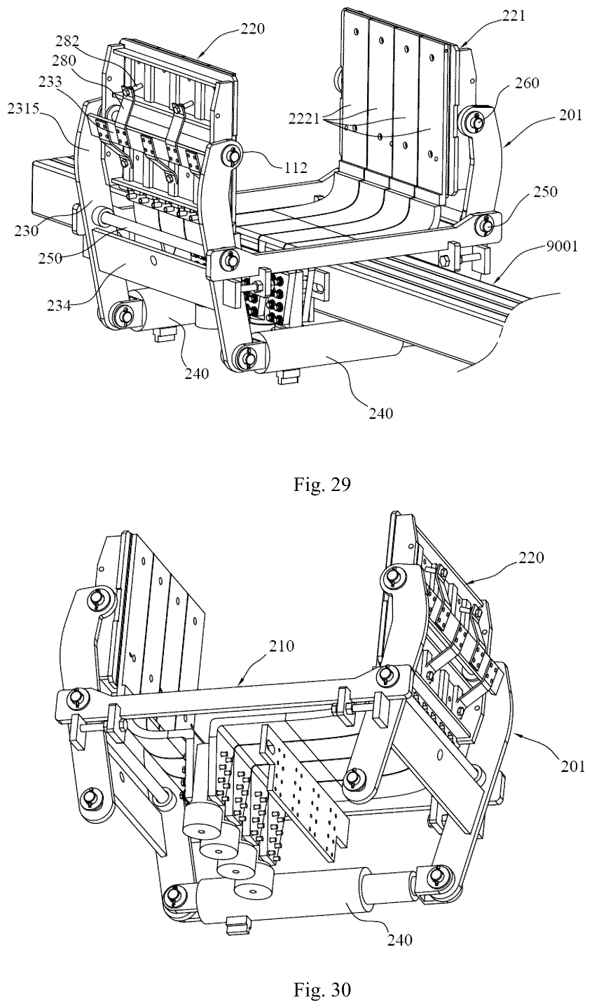

Referring to FIG. 22, FIG. 25, FIG. 28 and FIG. 29, in one embodiment, the first clamping component 201 comprises:
A first support frame 210,
Two first clamping arms 230, which are hinged with both sides of the first support frame 210 respectively, wherein the busbar clamping plates 220 are arranged on the first clamping arms 230 in a matching manner; and
A first driving part 240, which is arranged between the two first clamping arms 230 and connected with the two first clamping arms 230 respectively.

Both ends of the first support frame 210 are hinged with the middle parts of the two first clamping arms 230 respectively to form two supporting points, and the first clamping arms 230 and the first support frame 210 are all sheet plates in a long strip shape; and both ends of the first driving part 240 are hinged on first ends of the two first clamping arms 230 respectively, and second ends of the two first clamping arms 230 can be driven by the first driving part 240 to open and close around the supporting points. The first driving part 240 is a hydraulic cylinder in the present embodiment, and of course, can be a lead screw or a pneumatic cylinder in other embodiments, which will not be repeated herein.

Referring to FIG. 26, each busbar clamping plate 220 comprises a first clamping plate 221, and the two first clamping plates 221 are fixedly connected to the end of the corresponding first clamping arm 230 respectively, so the two first clamping plates 221 can be driven by the first clamping arms 230 to be close to or away from each other, so as to achieve an effect of clamping and loosening. Specifically, the first clamping plate 221 has a shape of rectangle and a size matched with the power transmission busbar, and it can be understood that the first clamping plate 221 can also be set to a circle, an oval or another geometrical shape, and relatively speaking, is easier to manufacture in a rectangle.

Referring to FIG. 22 to FIG. 24, the inside surface of each first clamping plate 221 is provided with a first conducting plate 222, and the first conducting plate 222 is used for conducting current by direct contact with the surface of the power transmission busbar. An elastic pad 229 is arranged between the first conducting plate 222 and the first clamping plate 221, the first conducting plate 222 is divided into a plurality of conducting strips arranged in parallel, and each conducting strip is a copper sheet 2221, for example, the present embodiment has four copper sheets 2221; and the elastic pad 229 is made of elastic material such as rubber plate, silica gel plate, PTFE plate, graphite pad, asbestos pad, ceramic fiber pad and fiberglass pad.

The working principle of the busbar clamping component 200 of the present embodiment is as follows:

The opening of the busbar clamping component 200 faces one side of the power transmission busbar, and the busbar clamping component 200 is moved to one side of the power transmission busbar during operation. When the power transmission busbar is located in the opening, the hydraulic cylinder drives and extends, the two first clamping arms 230 swing around the supporting points so that the second ends of the first clamping arms 230 are close to each other and finally drive the two first clamping plates 221 to clamp the two opposite surfaces of the power transmission busbar. Since the elastic pad 229 is arranged between the first conducting plate 222 and the first clamping plate 221, the first conducting plate 222 can be flexibly sunk into the first clamping plate 221 when squeezed; and since the first conducting plate 222 is divided into a plurality of copper sheets 2221 arranged in parallel, each copper sheet 2221 can be adaptively sunk alone in the whole area covered by the first conducting plate 222, which improves the sensitivity of the whole first conducting plate 222 to the surface fluctuation of the power transmission busbar, so as to ensure that the first conducting plate 222 can be fitted with the surface of the power transmission busbar closely and firmly, thus guaranteeing a stable and favorable conducting effect. When loosened, the hydraulic cylinder retracts and then drives the second ends of the first clamping arms 230 to open, and the first clamping plates 221 are detached from the power transmission busbar.

Referring to FIG. 22 to FIG. 25, in one embodiment, the two first clamping plates 221 are pivoted to the end of the corresponding first clamping arm 230 respectively so that the first clamping plates 221 can swing around the pivot. When the power transmission busbar is clamped by the busbar clamping component 200, the two first clamping plates 221 can also swing according to the position deviation of the power transmission busbar, so as to reduce excess stress between the busbar clamping component 200 and the power transmission busbar and prolong the service life of the busbar clamping component 200.

During actual production of Acheson graphitization furnaces, the position of the power transmission busbar is not in absolute alignment with the busbar clamping component 200, and due to long-term use, the power transmission busbar will also be subjected to a degree of bending deformation. The above contact-type structure can make up for poor contact caused by the uneven surface of the power transmission busbar and can also eliminate minor position deviation. However, if the overall shape of the power transmission busbar has large bending deformation, the busbar clamping component 200 and the power transmission busbar also have large torsion stress after clamping, which will consume more energy and accelerate the fatigue aging of relevant structural components. The first clamping plates 221 are arranged to be pivoted to the ends of the first clamping arms 230, and the two first clamping plates 221 can adapt to deformation of the power transmission busbar by swinging at a small angle to eliminate excess stress between the busbar clamping component 200 and the power transmission busbar due to deformation, thus solving the above problem.

Referring to FIG. 22 and FIG. 25, as a preferred solution, the ends of the two first clamping arms 230 away from the first driving part 240 are bent relative to each other to form bending parts 2315, and the first clamping plates 221 are connected to the ends of the bending parts 2315. The front end of each first clamping arm 230 is arranged to bend inward slightly, which is more conducive to transmission of force. and the first clamping plates 221 obtain more movement space inside the first clamping arms 230.

Furthermore, the end of each bending part 2315 is projected towards the direction of clamping to form a first convex part 2314, and the first clamping plate 221 is connected to the first convex part 2314. The arrangement will give the first clamping plates 221 a space for further moving inside the first clamping arms 230, which reduces mutual interference between the first clamping plates 221 and the first clamping arms 230 when swinging.

The first clamping component 201 in the above embodiment uses the lever principle to apply a force, i.e., each first clamping arm 230 is divided into an upper section and a lower section with the end point of the first support frame 210 as a supporting point, and the purpose of energy saving can be achieved by setting the length ratio of the upper section to the lower section. For example, in one specific embodiment. if the length ratio of the upper section to the lower section is set to 1.5:1, only one force is applied on the driving end to obtain 1.5 times the force on the clamping end, so as to achieve the purpose of reducing the pressure of the hydraulic cylinder.

Referring to FIG. 22, in the present embodiment, each first clamping arm 230 comprises two first gripper arms 231 and a first limiting plate 212 fixedly connected between the two first gripper arms 231, the first limiting plate 212 is used for connecting the two first gripper arms 231 into a whole, each first clamping arm 230 has a framework structure, and the two first clamping arms 230 are symmetrically arranged.

The first support frame 210 is provided with two first support plates 211 arranged in parallel, the two first support plates 211 are arranged along the extension direction of the power transmission busbar, both ends of each first support plate 211 are pivoted to the first gripper arm 231 on the corresponding side through the first rotating shaft 250, and the first rotating shaft 250 forms the supporting point as described above;

The number of the first driving parts 240 is two, the two first driving parts 240 are arranged in parallel, and both ends of each first driving part 240 are hinged with a first end of the first gripper arm 231 on the same side respectively; and the two first driving parts 240 are operated synchronously.

Each first clamping plate 221 is pivoted to the end of the first gripper arm 231 on the same side through the second rotating shaft 260 and can swing around the second rotating shaft 260.

The operating principle of the busbar clamping component 200 is as follows:

The opening of the busbar clamping component 200 faces one side of the power transmission busbar. and the busbar clamping component 200 is moved to below the power transmission busbar during operation. When the power transmission busbar is located in the opening, the two hydraulic cylinders drive and extend synchronously, the two first clamping arms 230 swing around the first rotating shaft 250 so that the second ends of the first clamping arms 230 are close to each other and finally drive the two first clamping plates 221 to clamp the two opposite surfaces of the power transmission busbar. Since the elastic pad 229 is arranged between the first conducting plate 222 and the first clamping plate 221, the first conducting plate 222 can be flexibly sunk into the first clamping plate 221 when squeezed; and since the first conducting plate 222 is divided into a plurality of copper sheets 2221 arranged in parallel, each copper sheet 2221 can be adaptively sunk alone in the whole area covered by the first conducting plate 222, which improves the sensitivity of the whole first conducting plate 222 to the surface fluctuation of the power transmission busbar, so as to ensure that the first conducting plate 222 can be fitted with the surface of the power transmission busbar closely and firmly, thus guaranteeing a stable and favorable conducting effect. When loosened, the two hydraulic cylinders retract synchronously and then drive the second ends of the first clamping arms 230 to open, and the first clamping plates 221 are detached from the power transmission busbar.

Referring to FIG. 29 and FIG. 30, it is worth mentioning that the busbar clamping component 200 is fixed on the power transmission vehicle device, and specifically, the vehicle body 1000 is provided with a crossbeam 9001 along the extension direction of the power transmission busbar, after assembly, the crossbeam 9001 passes through the space between the first support frame 210 and the first driving parts 240, and the first support frame 210 is fixed on the crossbeam 9001, so as to fix the whole busbar clamping component 200 on the vehicle body 1000. In the above embodiment, the design of arranging the two first driving parts 240 allows for more installation space below the whole busbar clamping component 200, which is conductive to arrangement and connection of connecting cables and reduces interference between structural components.

Referring to FIG. 22, as a preferred embodiment, the busbar clamping component 200 is also provided with a first limiting mechanism for limiting the amplitude of free swing of the first clamping plate 221 relative to the first clamping arm 230. Specifically, the first limiting mechanism comprises a first fixing plate 233, a plurality of first elastomers 280 and a plurality of first limiting bolts 282.

The first fixing plate 233 is fixedly connected to the outer side of the first clamping arm 230, and specifically connected between the two first gripper arms 231 and located on the outer side of the first clamping arm 230; and the first fixing plate 233 is perpendicular to the extension direction of the power transmission busbar.

Each first elastomer 280 is an arched sheet, one end of each first elastomer 280 is connected to the first fixing plate 233, the other end is extended upward or downward, and the plurality of first elastomers 280 are distributed on both sides of the first fixing plate 233 in a staggered manner, i.e., the upper side and the lower side of the first fixing plate 233 are provided with at least one first elastomer 280, for example, four first elastomers 280, two facing upward and two facing downward, are mutually staggered. The arched back surface of each first elastomer 280 faces outward, i.e., the plurality of first elastomers 280 are directed to the back surface of the first clamping plate 221 in a claw shape as a whole.

The end of each first elastomer 280 is provided with a screw hole, the first limiting bolt 282 is penetrated through the screw hole, and the length of the first limiting bolt 282 penetrating the screw hole can be adjusted.

The working principle of the first limiting mechanism is as follows:

The plurality of first elastomers 280 are directed to the back surface of the first clamping plate 221 in a claw shape, so the first clamping plate 221 is held by the first elastomers 280 when swinging around the second rotating shaft 260, so as to limit the swinging amplitude of the first clamping plate 221 so that the first clamping plate 221 cannot swing at a large angle; and the bolt penetrating the end of the first elastomer 280 can ensure that the first elastomers 280 on the same side hold the first clamping plate 221 synchronously and equally.

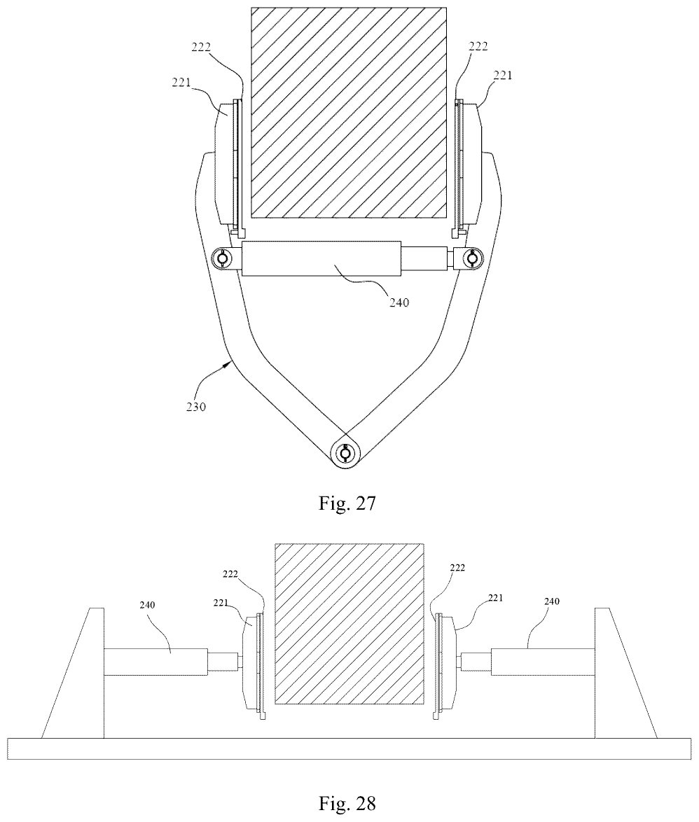

It should be noted that the first clamping component 201 using a lever structure employed in the above embodiment is only an optimal embodiment of the present application, but the structure of the first clamping component 201 of the present application is not limited hereto, for example, in other embodiments, the first clamping component 201 can also be arranged to have a V-clamp structure, i.e., the first ends of the two first clamping arms 230 are merged and hinged together, the second ends can be opened and closed, and the first driving part 240 is connected between the two first clamping arms 230 (as shown in FIG. 27); or the first clamping component can also be arranged to have a push-type structure (as shown in FIG. 28), i.e., two opposite sides are provided with a first driving part respectively, the first driving part is connected with the first clamping plate, and when it is necessary to clamp, the two first driving parts apply a force to the center so that the two first clamping plates can achieve the clamping function. The change of the first clamping component shall fall into the protection scope of the present application as long as the first clamping plate used for contact with the power transmission busbar adopts the essential spirit of the present application, that is a solution that the elastic pad 229 is arranged between the first conducting plate and the first clamping plate and the first conducting plate is divided into a plurality of strips.

It should be noted that the conducting electrode is arranged outside the furnace body and needs to be clamped by the electrode clamping plates to realize electrical connections, and at this moment, the electrode clamping plates are in surface contact with the conducting electrode. During actual production, the installation position of the conducting electrode cannot be absolutely accurate, and the vertical line of the section thereof is more or less deviated from the initial direction; and meanwhile, the deformation of the conducting electrode due to heating or cooling results in a gap between the conducting electrode and the electrode clamping plates which cannot be fitted closely, leading to a poor conducting effect and then affecting the quality of products manufactured by the Acheson graphitization furnace. In this way, the present embodiment specifically adopts the following structure to solve the problem of poor conducting effect due to inability to closely fit the electrode clamping plates and the conducting electrode.

Since the clamping structure of the electrode clamping component 300 is consistent with the clamping structure of the busbar clamping component 200, the clamping structure applied on the busbar clamping component 200 can also be applied on the clamping structure of the electrode clamping component 300, which will not be repeated herein.

### Embodiment 5

Different from embodiment 4, when the power transmission busbar transmits power to the conducting electrode through the busbar clamping plates, the busbar clamping plates will produce a lot of heat during operation, so as to keep the busbar clamping plates in a high temperature state (100-300° C.). and the busbar clamping plates will deform when heated, which will result in poor contact between the busbar clamping plates and the power transmission busbar and affect the effect of graphitization of the conducting electrode. In addition, if the busbar clamping plates are in a high temperature state for a long time, the aging thereof will be accelerated, which is not conductive to the prolongation of the service life of the busbar clamping plates. In this way, the present embodiment can also specifically adopt the following structure to solve the problems of poor contact and rapid aging caused by the busbar clamping plates in a high temperature state for a long time.

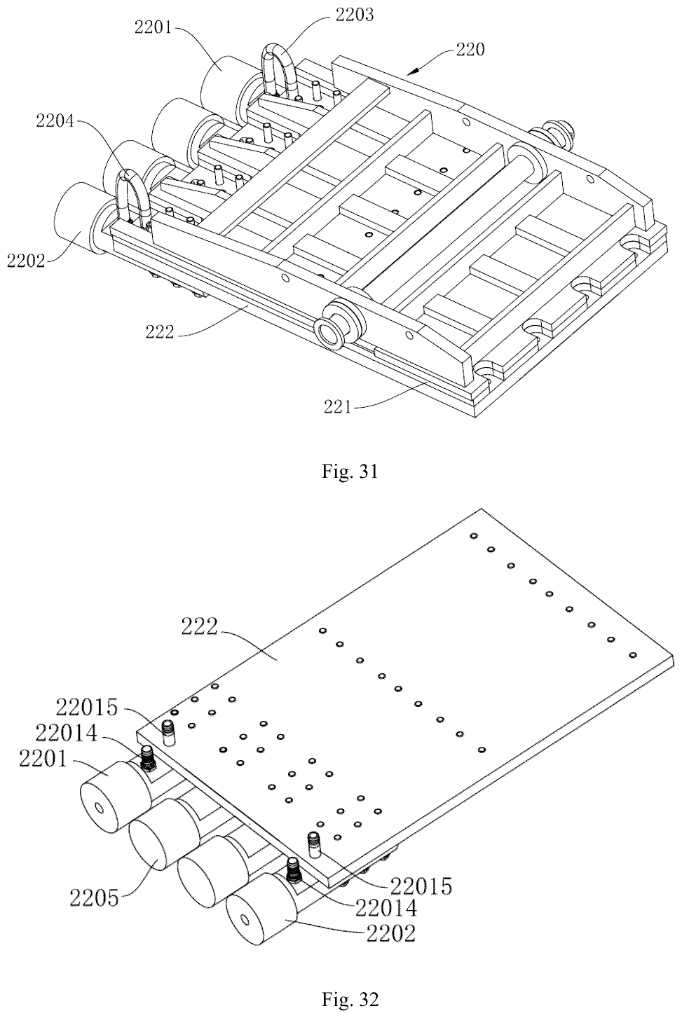

Referring to FIG. 31 to FIG. 37, in the present embodiment, the busbar clamping component 200 has a clamp-style structure using the lever principle, and the busbar clamping component 200 comprises:

Busbar clamping plates 220, which are used for clamping a power transmission busbar outside the furnace body.

In one embodiment, the busbar clamping component 200 also comprises:
A first support frame 210,
Two first clamping arms 230, which are hinged with both sides of the first support frame 210 respectively, wherein the busbar clamping plates 220 are arranged on the first clamping arms 230 in a matching manner; and
A first driving part 240, which is arranged between the two first clamping arms 230 and connected with the two first clamping arms 230 respectively.

Both ends of the first support frame 210 are hinged with the middle parts of the two first clamping arms 230 respectively to form two supporting points, and the first clamping arms 230 and the first support frame 210 are all sheet plates in a long strip shape; and both ends of the first driving part 240 are hinged on first ends of the two first clamping arms 230 respectively, and second ends of the two first clamping arms 230 can be driven by the first driving part 240 to open and close around the supporting points. The first driving part 240 is a hydraulic cylinder in the present embodiment, and of course, can be a lead screw or a pneumatic cylinder in other embodiments, which will not be repeated herein.

In the present embodiment, each first clamping arm 230 comprises two first gripper arms 231 and a first limiting plate 212 fixedly connected between the two first gripper arms 231, the first limiting plate 212 is used for connecting the two first gripper arms 231 into a whole, each first clamping arm 230 has a framework structure, and the two first clamping arms 230 are symmetrically arranged;

The first support frame 210 is provided with two first support plates 211 arranged in parallel, the two first support plates 211 are arranged in parallel, both ends of each first support plate 211 are pivoted to the first gripper arm 231 on the corresponding side through the first rotating shaft 250, and the first rotating shaft 250 forms the supporting point as described above;

The number of the first driving parts 240 is two, the two first driving parts 240 are arranged in parallel, and both ends of each first driving part 240 are hinged with a first end of the first gripper arm 231 on the same side respectively; and the two first driving parts 240 are operated synchronously.

Each first clamping plate 221 is pivoted to the end of the first gripper arm 231 on the same side through the second rotating shaft 260 and can swing around the second rotating shaft 260.

Each busbar clamping plate 220 comprises a first clamping plate 221 and a first conducting plate 222, the first conducting plate 222 is fixedly arranged on the first clamping plate 221 through bolts, the first conducting plate 222 is provided with a first conducting head 2201 and a second conducting head 2202, the first conducting head 2201 and the second conducting head 2202 are fixed on the first conducting plate 222 through bolts, one end of the first conducting head 2201 and one end of the second conducting head 2202 are arranged on the first conducting plate 222 to be connected with an external water cooling cable, the first conducting head 2201 and the second conducting head 2202 are used for transmitting power delivered by the power transmission busbar to the first conducting plate 222 through the water cooling cable, and then the first conducting plate 222 transmits the power to the power transmission vehicle device for use; in addition, the first conducting head 2201 is also used for receiving cooling water delivered by an external water supply device through the water cooling cable, and the second conducting head 2202 is used for returning the cooling water to the external water supply device through the water cooling cable, so as to achieve a recycling effect of the cooling water; specifically, the first conducting head 2201 and the second conducting head 2202 are provided with a connecting part 22011 and a fitting part 22012 which are integrated in one piece, the connecting part 22011 is used to be connected with the water cooling cable, and the fitting part 22012 is arranged on the first conducting plate 222 so that the first conducting head 2201 and the second conducting head 2202 are electrically connected with the first conducting plate 222; and in addition, the connection through other intermediate structures is avoided by connecting the first conducting head 2201 and the second conducting head 2202 directly with the first conducting plate 222, which effectively saves assembly parts, so as to reduce the manufacturing cost, and a cooling water pipeline of the busbar clamping plate 220 is redesigned according to the connection effect of the external water cooling cable and the first conducting head 2201 and the second conducting head 2202, which effectively reduces the flow path of cooling water on the premise of ensuring that the cooling efficiency is not reduced.

The first conducting head 2201 is communicated with the first conducting plate 222 through a first diversion tube 2203, the second conducting head 2202 is communicated with the first conducting plate 222 through a second diversion tube 2204, the first conducting plate 222 is provided with a cooling channel for the cooling water to flow through so that the cooling water enters the first conducting plate 222 through the first diversion tube 2203 and then flows out through the cooling channel and the second diversion tube 2204 to realize cooling operation on the first conducting plate 222 and effectively cool the first conducting plate 222 so that the busbar clamping plates 220 will not work in a high temperature state for a long time, thus prolonging the service life of the busbar clamping plates 220; specifically, one end of the first diversion tube 2203 is connected with the first conducting head 2201, and the other end of the first diversion tube 2203 is connected with the first conducting plate 222, so as to transport cooling water delivered by the water cooling cable to the first conducting plate 222 through the first conducting head 2201 and the first diversion tube 2203; and one end of the second diversion tube 2204 is connected with the second conducting head 2202, and the other end of the second diversion tube 2204 is connected with the first conducting plate 222, so as to return the cooling water flowing through the first conducting plate 222 to the external water supply device through the second diversion tube 2204, the second conducting head 2202 and the water cooling cable to achieve a recycling effect of the cooling water.

Further, a water flow channel 22013 is arranged in the first conducting head 2201 and the second conducting head 2202 respectively for the cooling water to flow between the first conducting plate 222 and the corresponding water cooling cable through the corresponding first diversion tube 2203 and second diversion tube 2204; and specifically, the water flow channel 22013 in the first conducting head 2201 is used for transporting the cooling water delivered by the external water cooling cable to the first conducting plate 222 through the first diversion tube 2203, and the second conducting head 2202 is used for returning the cooling water in the first conducting plate 222 to the responding water cooling cable through the second diversion tube 2204.

In one embodiment, the first conducting head 2201 and the second conducting head 2202 are provided with a first drainage tube 22014 connected with the water flow channel 22013, the first drainage tube 22014 is used to be connected with the corresponding first diversion tube 2203 and second diversion tube 2204, and the first drainage tube 22014 is arranged outside the first conducting head 2201 and the second conducting head 2202 to facilitate connection with the corresponding first diversion tube 2203 and second diversion tube 2204.

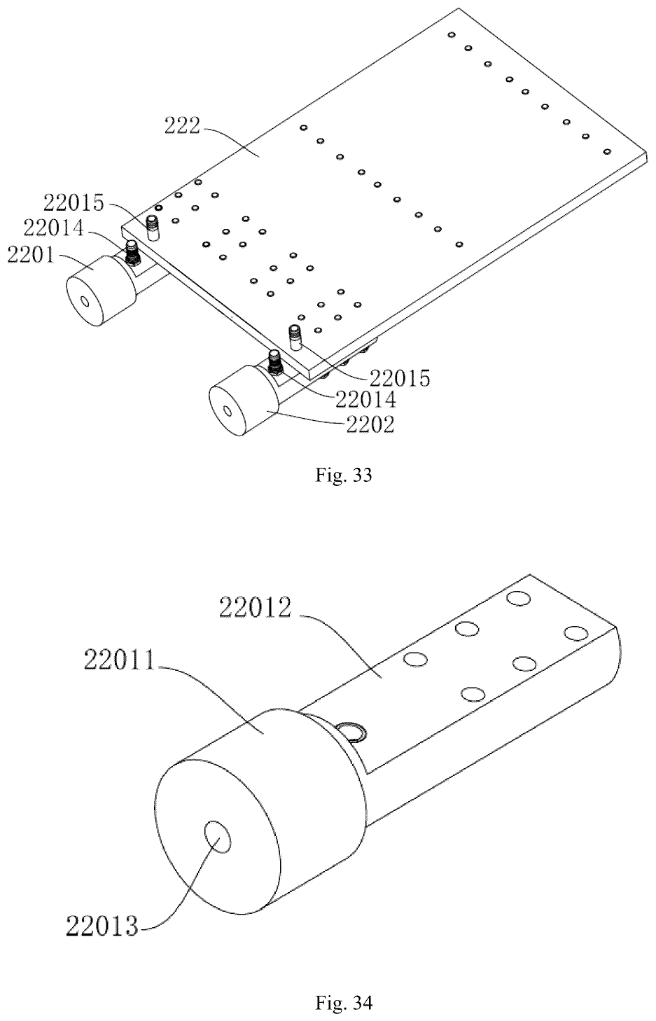

As shown in FIG. 32 and FIG. 33, in one embodiment, the first conducting plate 222 is provided with a second drainage tube 22015 connected with the cooling channel, the second drainage tube 22015 is used to be connected with the corresponding first diversion tube 2203 and second diversion tube 2204, and the second drainage tube 22015 is arranged outside the first conducting plate 222 to facilitate connection with the corresponding first diversion tube 2203 and second diversion tube 2204.

In one embodiment, the first conducting plate 222 is integrated in one piece, the cooling channel is arranged in a serpentine shape in the first conducting plate 222, a water inlet end of the cooling channel is connected with the first diversion tube 2203, a water outlet end of the cooling channel is connected with the second diversion tube 2204, the specific fixed positions of the first conducting head 2201 and the second conducting head 2202 on the first conducting plate 222 are not limited, and the first conducting head 2201 and the second conducting head 2202 can be arranged on the same side of the first conducting plate 222 or arranged on different sides of the first conducting plate 222 as required; in other embodiments, the cooling channel can also be arranged in other curved shapes in the first conducting plate 222, which are not enumerated herein, to facilitate the cooling water to flow into or out of the first conducting plate 222; and in the present embodiment, the first conducting plate 222 can be provided with a plurality of first conducting heads 2201 and second conducting heads 2202 and can realize cooling water supply to the first conducting plate 222 through a plurality of water cooling cables, a third conducting head 2205 can also be arranged to be connected with the first conducting plate 222, and the third conducting head 2205 conducts the power delivered by the power transmission busbar only through cables without the water flow channel 22013, so as to further ensure stable electrical connection between the power transmission busbar and the first conducting plate 222.

Alternatively, the first conducting plate 222 comprises at least one first conducting strip 22201 and at least one second conducting strip 22202, wherein the first conducting strip 22201 and the second conducting strip 22202 are made of copper sheets, the first conducting strip 22201 and the second conducting strip 22202 are arranged side by side, the first conducting head 2201 is fixedly connected to the first conducting strip 22201 through bolts, and the second conducting head 2202 is fixedly connected to the second conducting strip 22202 through bolts; and one end of the first diversion tube 2203 is connected with the first conducting head 2201, the other end of the first diversion tube 2203 is connected with the first conducting strip 22201, one end of the second diversion tube 2204 is connected with the second conducting head 2202, the other end of the second diversion tube 2204 is connected with the second conducting strip 22202, the first conducting strip 22201 and the second conducting strip 22202 are connected through a third diversion tube 2206 so that the cooling water delivered by the water cooling cable is transported to the first conducting strip 22201 through the first conducting head 2201 and the first diversion tube 2203 and then returned to the external water supply device through the third diversion tube 2206, the second conducting strip 22202, the second diversion tube 2204, the second conducting head 2202 and the water cooling cable in sequence, which effectively cools the first conducting strip 22201 and the second conducting strip 22202 while recycling the cooling water so that the busbar clamping plates 220 will not work in a high temperature state for a long time, thus prolonging the service life of the busbar clamping plates 220.

In one embodiment, the first conducting strip 22201 and the second conducting strip 22202 are vertically arranged on the first clamping plate 221, the arrangement of the first conducting strip 22201 and the second conducting strip 22202 on the first clamping plate 221 is not limited, the first conducting strip 22201 and the second conducting strip 22202 can be arranged on the first clamping plate 221 in a staggered manner, or at least two first conducting strips 22201 are arranged side by side and then arranged on the first clamping plate 221 in a mode of staggering with the second conducting strip 22202, the cooling water is transported by the first diversion tube 2203, the cooling water flows between the first conducting strips 22201 and the second conducting strip 22202 in conjunction with the third diversion tube 2206, and the cooling water is recycled by the second diversion tube 2204, which effectively cools the first conducting plate 222 so that the busbar clamping plates 220 will not work in a high temperature state for a long time, thus prolonging the service life of the busbar clamping plates 220.

In one embodiment, a first cooling channel is arranged in the first conducting strip 22201, a second cooling channel is arranged in the second conducting strip 22202, the first cooling channel is arranged in a straight line in the first conducting strip 22201, the second cooling channel is arranged in a straight line in the second conducting strip 22202, and in the present embodiment, the cooling channel is composed of the first cooling channel, the second cooling channel and the third diversion tube 2206; in the first conducting strip 22201, a water inlet end of the first cooling channel is connected with the first diversion tube 2203, and a water outlet end of the first cooling channel is connected with the third diversion tube 2206; in the second conducting strip 22202, a water inlet end of the second cooling channel is connected with the third diversion tube 2206, a water outlet end of the second cooling channel is connected with the second diversion tube 2204, the cooling water is transported by the first diversion tube 2203, the cooling water flows between the first conducting strip 22201 and the second conducting strip 22202 in conjunction with the third diversion tube 2206, and the cooling water is returned by the second diversion tube 2204, which effectively cools the first conducting plate 222 so that the busbar clamping plates 220 will not work in a high temperature state for a long time, thus prolonging the service life of the busbar clamping plates 220; and in other embodiments, the first cooling channel and the second cooling channel can also be arranged in a curved shape such as a serpentine shape in the corresponding first conducting strip 22201 and second conducting strip 22202, which is not enumerated herein, to facilitate the cooling water to flow into or out of the first conducting strip 22201 or the second conducting strip 22202.

Further, the flow path of cooling water in the first conducting plate 222 is increased to improve the cooling efficiency of the first conducting strip 22201 and the second conducting strip 22202 in the following ways: the first diversion tube 2203 and the second diversion tube 2204 are arranged on one end of the first conducting strip 22201 and one end of the second conducting strip 22202 respectively, both ends of the third diversion tube 2206 are connected with the other end of the first conducting strip 22201 and the other end of the second conducting strip 22202 respectively so that the path of cooling water flowing through the first conducting strip 22201 and the second conducting strip 22202 forms a U-shaped structure, which effectively increases the total flow path of the cooling water in the first conducting strip 22201 and the second conducting strip 22202, thus improving the cooling efficiency of the first conducting strip 22201 and the second conducting strip 22202.

In one embodiment, to ensure smooth flow of the cooling water from the first conducting head 2201 to the first conducting plate 222 and from the first conducting plate 222 to the second conducting head 2202, the first diversion tube 2203 and the second diversion tube 2204 both have a U-shaped structure. In addition, to ensure smooth flow of the cooling water from the first conducting strip 22201 to the second conducting strip 22202, the third diversion tube 2206 has a U-shaped structure.

In one embodiment, to facilitate the installation arrangement of the first diversion tube 2203, the second diversion tube 2204 and the third diversion tube 2206, the first clamping plate 221 is provided with grooves matched with the first diversion tube 2203, the second diversion tube 2204 and the third diversion tube 2206 respectively, so as to facilitate the first diversion tube 2203, the second diversion tube 2204 and the third diversion tube 2206 to be connected with the first conducting plate 222 after avoiding the block of the physical structure of the first clamping plate 221.

Taking the first conducting plate 222 comprising at least one first conducting strip 22201 and at least one second conducting strip 22202 as an example, when the busbar clamping plates 220 of the present application work, the busbar clamping plates 220 are connected with the power transmission busbar, the power transmission busbar transmits power to the power transmission vehicle device through the busbar clamping plates 220, and the current flowing through the busbar clamping plates 220 will cause the first conducting plate 222 to heat up; and at this moment, the external water supply device is started, the cooling water is transported to the first conducting strip 22201 by the water cooling cables through the first conducting head 2201 and the first diversion tube 2203 and then transported to the second conducting strip 22202 from the first conducting strip 22201 through the third diversion tube 2206, and finally, the cooling water in the second conducting strip 22202 is returned to the external water supply device through the second diversion tube 2204, the second conducting head 2202 and the water cooling cable, which effectively cools the first conducting strip 22201 and the second conducting strip 22202 so that the busbar clamping plates 220 will not work in a high temperature state for a long time, thus prolonging the service life of the busbar clamping plates 220 and achieving a recycling effect of the cooling water.

It should be noted that the conducting electrode is in a high temperature state (about 300° C.) during operation and will transmit the heat to the electrode clamping plates of the electrode clamping component 300 directly connected therewith, and the electrode clamping plates will deform when heated, which will result in poor contact between the electrode clamping plates and the conducting electrode and affect the effect of graphitization of the conducting electrode. In addition, if the electrode clamping plates are in a high temperature state for a long time, the aging thereof will be accelerated. In this way, the present embodiment can also specifically adopt the following structure to solve the problems of poor contact and rapid aging caused by the electrode clamping plates in a high temperature state for a long time.

Since the cooling structure of the electrode clamping component 300 is consistent with the cooling structure of the busbar clamping component 200, the cooling structure applied on the electrode clamping component 300 can also be applied on the structure of the busbar clamping component 200, which will not be repeated herein.

### Embodiment 6

Different from conventional workpieces, to ensure stable fit with the power transmission busbar, the busbar clamping component 200 is generally designed as a movable busbar clamping plate structure, which will result in uncertainty in the initial clamping angle of the busbar clamping plate; when the busbar clamping plate is close to the power transmission busbar, the width of the opening between the busbar clamping plates is too small or too large; when the width of the opening between the busbar clamping plates is too small, the power transmission busbar cannot enter the opening of the clamp structure, leading to damage to the power transmission busbar; and when the width of the opening between the busbar clamping plates is too large, the clamp structure cannot clamp the power transmission busbar after the power transmission busbar enters the opening of the clamp structure, which affects the conducting effect. In this way, the present embodiment can also specifically adopt the following structure to solve the problem that the busbar clamping plates cannot clamp the power transmission busbar stably due to that the opening between the busbar clamping plates is not suitable for the power transmission busbar.

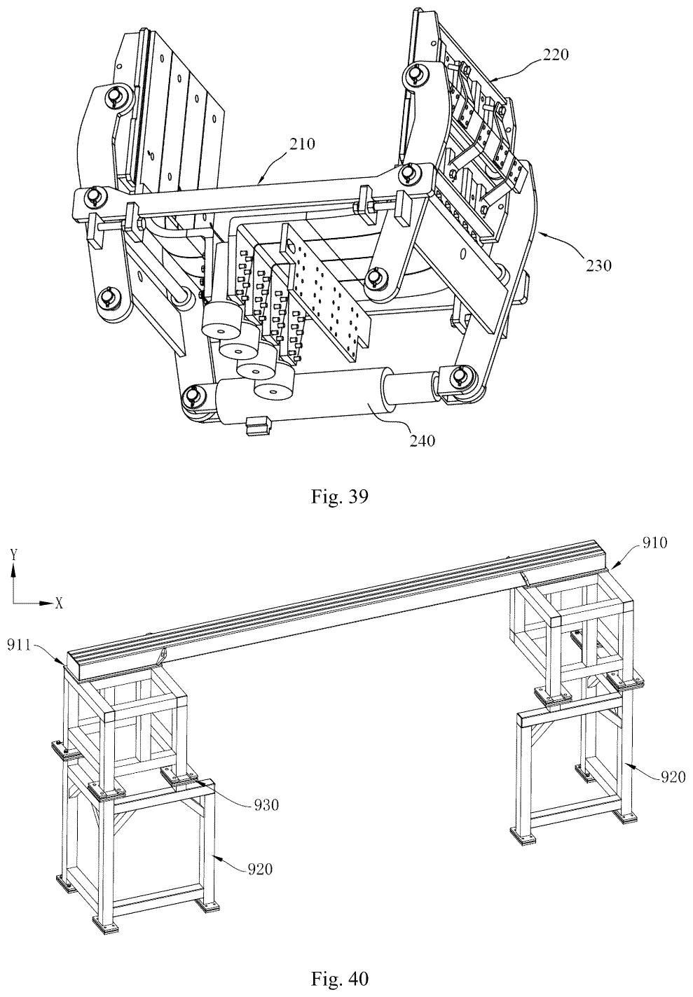

Referring to FIG. 38 and FIG. 39, the power transmission busbar clamping mechanism 3000 also comprises a base frame 900, the base frame 900 is also provided with a crossbeam 9001, and the busbar clamping component 200 is arranged on the crossbeam 9001 and used for clamping a power transmission busbar;

The busbar clamping component 200 comprises:
A first support frame 210, which is arranged on the base frame 900;
Two busbar clamping plates 220 arranged oppositely, wherein the two busbar clamping plates 220 realize clamping operation of a power transmission busbar on a furnace body together;
Two first clamping arms 230, which are hinged with both sides of the first support frame 210 respectively, wherein the two busbar clamping plates 220 are arranged on the two first clamping arms 230 respectively; and
A first driving part 240, which is arranged between the two first clamping arms 230 and connected with the two first clamping arms 230 respectively.

Both sides of the first support frame 210 are hinged with the middle parts of the two first clamping arms 230 respectively to form two supporting points, and the first clamping arms 230 and the first support frame 210 are all sheet plates in a long strip shape; and both ends of the first driving part 240 are hinged on first ends of the two first clamping arms 230 respectively, and the second ends of the two first clamping arms 230 can be driven by the first driving part 240 to open and close around the supporting points, so as to drive the two busbar clamping plates 220 to be close to or away from each other, thus realizing clamping or loosening operation on the power transmission busbar. The first driving part 240 is a hydraulic cylinder in the present embodiment, and of course, can be a lead screw or a pneumatic cylinder in other embodiments, which will not be repeated herein.

Both sides of the first support frame 210 are hinged with the first clamping arm 230 on the corresponding side respectively through a first rotating shaft 250, and the first rotating shaft 250 forms the supporting point as described above.

Each busbar clamping plate 220 is hinged on the end of the first clamping arm 230 on the corresponding side through a second rotating shaft 260, and the busbar clamping plate 220 can be arranged in a mode of swinging around the second rotating shaft 260; and specifically, when the first driving part 240 drives the first clamping arms 230 to approach each other, the busbar clamping plates 220 on the first clamping arms 230 will gradually approach the power transmission busbar, and the busbar clamping plates 220 will rotate with the second rotating shaft 260 as an axis for self-adjustment according to actual needs to ensure close fit with the power transmission busbar, so as to maximize the contact area of the busbar clamping plates 220 and the power transmission busbar, thus increasing the electrical conduction efficiency.

In one embodiment, at least one first clamping arm 230 is provided with at least one first elastomer 280, the first elastomer 280 has a shrapnel structure, a limiting part 281 is extended from the first elastomer 280 in a bending manner, the limiting part 281 is abutted against one side of the busbar clamping plate 220, and the limiting part 281 is used for limiting the initial installation angle of the busbar clamping plate 220, so as to adapt to the width setting of the power transmission busbar; and in other embodiments, the two first clamping arms 230 can be provided with at least one first elastomer 280 respectively as required.

When only one first elastomer 280 is arranged near one end of the busbar clamping plate 220 towards the power transmission busbar, the power transmission busbar is clamped by the busbar clamping component 200, wherein the busbar clamping plate 220 on the first clamping arm 230 on one side moves towards the direction of pressing against the first elastomer 280, and the busbar clamping plate 220 on the first clamping arm 230 on the other side, which is not provided with the first elastomer 280, rotates with the second rotating shaft 260 as an axis by matching with the surface of the power transmission busbar, so as to maximize the contact area of the busbar clamping plates 220 and the power transmission busbar. thus improving the electrical conduction efficiency.

In one embodiment, when the first clamping arm 230 is provided with at least two first elastomers 280, the limiting parts 281 of at least two first elastomers 280 are arranged on both sides of the second rotating shaft 260 respectively, so as to ensure that the busbar clamping plate 220 is withstood by the limiting part 281 on the corresponding side when rotating forwards or backwards with the second rotating shaft 260 as an axis, thus ensuring that the opening corresponding to the initial installation angle of the busbar clamping plate 220 on the first clamping arm 230 is suitable for the width of the power transmission busbar, and before the power transmission busbar is clamped by the busbar clamping plates 220, the width of the opening between the busbar clamping plates 220 can adapt to the size of the power transmission busbar; and when the power transmission busbar is clamped by the busbar clamping plates 220, the busbar clamping plates 220 can form a stable fit relationship with the power transmission busbar to ensure the contact area of the busbar clamping plates 220 and the power transmission busbar.

In one embodiment, the first clamping arm 230 is provided with a first fixing plate 233, the first elastomers 280 are arranged on the first fixing plate 233 at intervals, the limiting parts 281 located on both sides of the first fixing plate 233 are also arranged on both sides of the second rotating shaft 260 respectively, so as to ensure that the busbar clamping plate 220 is withstood by the limiting part 281 on the corresponding side when rotating forwards or backwards with the second rotating shaft 260 as an axis, thus ensuring that the opening corresponding to the initial installation angle of the busbar clamping plate 220 on the first clamping arm 230 is suitable for the width of the power transmission busbar, and before the power transmission busbar is clamped by the busbar clamping plates 220, the width of the opening between the busbar clamping plates 220 can adapt to the size of the power transmission busbar; and when the power transmission busbar is clamped by the busbar clamping plates 220, the busbar clamping plates 220 can form a stable fit relationship with the power transmission busbar to ensure the contact area of the busbar clamping plates 220 and the power transmission busbar.

In other embodiments, the first elastomers 280 are arranged on the first clamping arms 230 to match both ends of the busbar clamping plate 220 to limit both ends of the busbar clamping plate 220 respectively, so as to limit the initial installation angle of the busbar clamping plate 220, thus meeting the width requirement of the power transmission busbar.

In one embodiment, the first fixing plate 233 is provided with fixing holes, one end of each first elastomer 280 is fixed on the first fixing plate 233 through screws, and the screws pass through one end of the first elastomer 280 and are stuck in the fixing holes.

In one embodiment, the limiting part 281 is provided with screw holes, a first limiting bolt 282 is arranged in each screw hole, the first limiting bolt 282 is stuck in the screw hole, one end of the first limiting bolt 282 is abutted against one side of the busbar clamping plate 220, and the initial installation angle of the busbar clamping plate 220 is adjusted by adjusting the length of one end of the first limiting bolt 282 extending from the screw hole, so as to adapt to power transmission busbars of different sizes.

In one embodiment, the busbar clamping plate 220 is convexly provided with a buffer block 401 towards one side of the limiting part 281, and the buffer block 401 is abutted against the limiting part 281, so as to increase the contact area of the limiting part 281 and the busbar clamping plates 220, thus avoiding damage to the busbar clamping plates 220 caused by excessive pressure of the limiting part 281 on the busbar clamping plates 220; and in the present embodiment, the buffer block 401 is abutted against one end of the first limiting bolt 282, so as to increase the contact area of the first limiting bolt 282 and the busbar clamping plates 220, thus avoiding damage to the busbar clamping plates 220 caused by excessive pressure of the first limiting bolt 282 on the busbar clamping plates 220.

In one embodiment, the first driving part 240 is arranged on one end of the first clamping arm 230 away from the busbar clamping plate 220 or can be arranged on one end of the first clamping arm 230 near the busbar clamping plate 220 as required, and the first clamping arm 230 is driven to rotate with the first rotating shaft 250 as an axis, so as to drive the busbar clamping plates 220 to be close to or away from each other, thus completing clamping or loosening operation on the external power transmission busbar.

Specifically, the distance between the first driving part 240 and the first rotating shaft 250 is greater than the distance between the first rotating shaft 250 and the second rotating shaft 260, and in the present embodiment, the ratio of the two distances is (1.4-1.6):1, so as to use the lever principle to make the first driving part 240 provide a smaller force so that the busbar clamping plates 220 produce a larger clamping force on a graphite busbar. In addition, the busbar clamping plates 220 and the first driving part 240 are arranged on both ends of the first clamping arm 230 respectively to drive the first clamping arm 230 in conjunction with the first driving part 240 to rotate with the first rotating shaft 250 as an axis, which ensures the arrangement of the first driving part 240 away from the busbar clamping plates 220 so that the first driving part 240 will be kept away from the heat source generated by the power transmission busbar after the busbar clamping plates 220 clamp the power transmission busbar, thus avoiding reduction of the service life of the first driving part 240 due to that the heat generated by the power transmission busbar is too close to the first driving part 240.

In one embodiment, each busbar clamping plate 220 comprises a first clamping plate 221 and a first conducting plate 222, the second rotating shaft 260 is arranged by penetrating the first conducting plate 222, and the first conducting plate 222 can rotate with the second rotating shaft 260 as an axis; and the first conducting plate 222 is fixed on the first clamping plate 221, the buffer block 401 is formed by convex arrangement of the first clamping plate 221 towards one side of the limiting part 281, and the first conducting plate 222 is made of flexible copper tape, which facilitates the formation of a limiting effect on the first clamping plate 221 using the flexibility of the first conducting plate 222 after the first conducting plate 222 is bent and extended from the first clamping plate 221, and also effectively improves the stability of the initial installation angle of the busbar clamping plate 220.

In one embodiment, the first clamping arm 230 has a hollow structure near the first fixing plate 233, so as to facilitate the first elastomer 280 to limit the initial installation angle of the busbar clamping plate 220; one end of the first clamping arm 230 near the first driving part 240 has a V-shaped structure, so as to facilitate leaving enough space between two adjacent busbar clamping components 200 on the struts 100 for installing other mechanisms; and specifically, a first conducting block is installed between two adjacent busbar clamping components 200 on the struts 100, and one end of the first conducting block is connected with the power transmission busbar clamping mechanism 3000 through a connecting cable.

Specifically, each first clamping arm 230 comprises two first gripper arms 231, and the two first gripper arms 231 are hinged at the supporting point of the first support frame 210; and one end of one first gripper arm 231 is fixed together with that of the other first gripper arm 231 through a connecting rod 232, the other end of one first gripper arm 231 is fixed together with that of the other first gripper arm 231 through a first fixing plate 233, both ends of the first driving part 240 are connected with the connecting rod 232 respectively, the first driving part 240 drives the two first gripper arms 231 to move together by driving the connecting rod 232 to move, so as to achieve an operation effect of driving the busbar clamping plates 220 to clamp or loosen the power transmission busbar.

Further, each first gripper arm 231 comprises a connecting part 2311, a bending part 2312 and a clamping part 2313 which are integrated in one piece, the two connecting parts 2311 are arranged in parallel, both ends of the connecting rod 232 are fixed on the two connecting parts 2311 respectively, and the bending parts 2312 of the two first gripper arms 231 form a V-shaped structure, so as to facilitate leaving enough space between two adjacent busbar clamping components 200 on the struts 100 for installing external mechanisms such as first conducting block; and the clamping parts 2313 of the two first gripper arms 231 on the same side are arranged in parallel, the busbar clamping plate 220 is arranged on one side of the corresponding clamping part 2313, and the first driving part 240 drives the two first gripper arms 231 on the same side to move together by driving the connecting rod 232 to move, so as to achieve an operation effect of driving the busbar clamping plates 220 to clamp or loosen the power transmission busbar.

The first clamping arm 230 is provided with a first limiting plate 212 on one side near the connecting rod 232, and both ends of the first limiting plate 212 are connected with the two first gripper arms 231 respectively, so as to enhance the structural stability of the first clamping arm 230.

The first support frame 210 is provided with two first support plates 211 arranged in parallel, and both ends of each first support plate 211 are hinged to the first gripper arm 231 on the corresponding side through the first rotating shaft 250.

During specific assembly of the present application, the initial installation angle of the busbar clamping plate 220 is designed according to the size of a power transmission busbar to be clamped, after the busbar clamping plate 220 is fixed on the first clamping arm 230, an appropriate first elastomer 280 is installed and fixed on the first fixing plate 233 to limit one side of the busbar clamping plate 220 or directly adjust the extension length of the first limiting bolt 282 arranged on the first elastomer 280 towards one side of the busbar clamping plate 220 so as to complete setting of the initial installation angle of the busbar clamping plate 220, and when the power transmission busbar is not clamped by the busbar clamping plates 220, the limiting force of the first elastomer 280 on the busbar clamping plates 220 cannot displace the limiting part 281; and when the first driving part 240 drives the first clamping arms 230 to clamp the power transmission busbar, the busbar clamping plates 220 will rotate at a small angle to increase the contact area with the power transmission busbar, and since the busbar clamping plates 220 apply a large clamping force to the power transmission busbar, the busbar clamping plates 220 also apply a larger force on the first elastomer 280 so that the limiting part 281 moves towards the direction of the force of the busbar clamping plates 220 to adjust the angle at which the power transmission busbar is clamped by the busbar clamping plates 220.

### Embodiment 7

Different from conventional workpieces, the power transmission vehicle device is connected with the power transmission busbar through the power transmission busbar clamping mechanism 3000 when transmitting power to an Acheson graphitization furnace, and the power transmission busbar clamping mechanism 3000 has a heavy weight, so the support structure of the power transmission vehicle device used for fixing the power transmission busbar clamping mechanism 3000 needs to have high structural strength and is generally made of metal. However, the metal is generally conductive. When the power transmission vehicle device is connected with the power transmission busbar to access high voltage, overvoltage easily causes electrical breakdown in the support structure, which may cause operators to touch the support structure by mistake and thus result in a safety accident, thus reducing the power transmission safety of the power transmission vehicle. In this way, the present embodiment specifically adopts the following structure to solve the problem of a safety accident due to that operators may touch the support structure by mistake.

Referring to FIG. 40 to FIG. 43, the power transmission busbar clamping mechanism 3000 also comprises a base frame 900, the base frame 900 is arranged on the vehicle body 1000, and the base frame 900 comprises a mounting framework 910, a support framework 920 and an insulating connecting component 930. The mounting framework 910 is configured for installation of the busbar clamping component 200 of the power transmission vehicle device. The support framework 920 is connected with the mounting framework 910 along a first direction. The insulating connecting component 930 has an insulating connecting area and an insulating edge area arranged around the insulating connecting area, and the insulating connecting area is connected between the mounting framework 910 and the support framework 920, wherein the area S1 of a first surface of the insulating connecting component 930 is greater than or equal to the contact area S3 of the mounting framework 910 and the insulating connecting area, the area of a second surface of the insulating connecting component 930 is greater than or equal to the contact area of the support framework 920 and the insulating connecting area, and the first surface and the second surface are arranged oppositely.

In the present embodiment, the contact area S3 refers to the contact area of the surface of the mounting framework 910 and the insulating connecting area when the mounting framework 910 is in contact with the insulating connecting area, and the contact area S4 refers to the contact area of the surface of the support framework 920 and the insulating connecting area when the support framework 920 is in contact with the insulating connecting area.

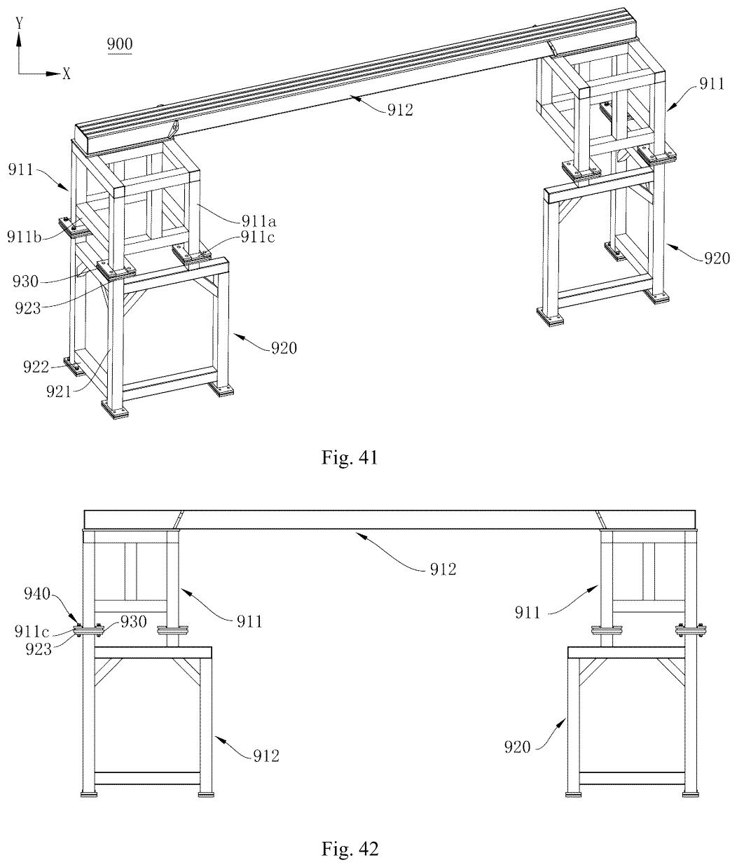

In the present embodiment, the first direction is the direction indicated by Y in FIG. 41, that is the direction perpendicular to the horizontal plane.

In one embodiment, the height of the base frame 900 along the first direction can be designed according to the height of the Acheson graphitization furnace, which is not specified in the embodiments of this description. In some embodiments, the height of the base frame 900 along the first direction is about 4 m. For the convenience of transportation and assembly, the base frame 900 comprises a mounting framework 910 and a support framework 920, and the mounting framework 910 and the support framework 920 can be connected along the first direction, wherein the height of the mounting framework 910 is about 2 m, and the height of the support framework 920 is about 2 m. Operators working on the ground can easily touch the support framework 920 by mistake. Therefore, the base frame 900 provided by the embodiments of this description also comprises an insulating connecting component 930, and the insulating connecting component 930 has an insulating connecting area and an insulating edge area arranged around the insulating connecting area, wherein the insulating connecting area is connected between the mounting framework 910 and the support framework 920, the area of one surface of the insulating connecting component 930 is greater than or equal to the contact area of the mounting framework 910 and the insulating connecting area, and the area of one surface of the insulating connecting component 930 is greater than or equal to the contact area of the support framework 920 and the insulating connecting area, which can form a brim structure, thus cutting off electric clearance between the mounting framework 910 and the support framework 920 (the electric clearance refers to the shortest distance between the mounting framework 910 and the support framework 920 that can be insulated by air while ensuring stable and safe electrical performance) and increasing the creepage distance between the mounting framework 910 and the support framework 920 (the creepage distance refers to the shortest path between the mounting framework 910 and the support framework 920 measured along the surface of the insulating connecting component 930) so that the phenomenon of electrical breakdown caused by overvoltage between the mounting framework 910 and the support framework 920 is reduced, so as to improve the power transmission safety of the power transmission vehicle device.

In the above embodiments, since the height of the mounting framework 910 is about 2 m, the height of the support framework 920 is about 2 m, and operators can hardly reach the mounting framework 910 when working on the ground, electrical protection of the mounting framework 910 can be omitted based on the manufacturing cost of the base frame 900 and the difficulty in reaching the mounting framework 910.

In one embodiment, the mounting framework 910 is provided with an uncharged identification area, and the support framework 920 is provided with a charged identification area, which can alert the operators and reduce accidents of electric shock caused by touch by mistake. Moreover, in other embodiments, to improve the warning effect, the uncharged identification area and the charged identification area can be separately painted in different colors, for example, the uncharged identification area can be coated with yellow paint, and the charged identification area can be coated with red paint.

In addition, the mounting framework 910 and the support framework 920 can be made of any metal well known in the art, such as copper, iron and alloy thereof, which is not specified in the embodiments of this description. Moreover, the insulating connecting component 930 can also be made of any insulating material well known in the art, such as plastic. quartz or high-temperature resistant rubber, which is not specified in the embodiments of this description.

Referring to FIG. 41, in one embodiment, the mounting framework 910 comprises two mounting framework bodies 911 and a crossbeam 9001. The two mounting framework bodies 911 are arranged at intervals along a second direction, wherein the first direction intersects with the second direction. The crossbeam 9001 is connected between the two mounting framework bodies 911 and configured for installation of the busbar clamping component 200 of the power transmission vehicle device.

In the present embodiment, the second direction is the X direction shown in FIG. 41, that is the direction parallel to the horizontal plane.

In the above embodiments, the crossbeam 9001 is not only used for installation of the busbar clamping component 200 of the power transmission vehicle device, but also connected between the two mounting framework bodies 911 to enhance the support stability of the base frame 900. The two mounting framework bodies 911 are connected with the support framework 920 respectively through the insulating connecting component 930 to further enhance the support stability of the base frame 900.

Referring to FIG. 41, in one embodiment, each mounting framework body 911 comprises at least four first legs 911a, a first connecting part 911b and a first contact part 911c. The first connecting part 911b is connected between two adjacent first legs 911a so that at least four first legs 911a are enclosed to form the mounting framework body 911. The first contact part 911c is arranged on a second end of the first leg 911a, and the contact surface area of the first contact part 911c is larger than the surface area of the second end of the first leg 911a. wherein the first contact part 911c is connected with the insulating connecting component 930.

In the above embodiments, each mounting framework body 911 is composed of at least four first legs 911a, a first connecting part 911b and a first contact part 911c, which can provide a good support for the crossbeam 9001 and the busbar clamping component 200 and also enhance the support stability of the base frame 900.

It should be noted here that the surface area of the first contact part 911c can be understood as the contact area S3.

Moreover, a gap between the two mounting framework bodies 911 can also be used for installation of the busbar clamping component 200, which can make full use of the gap between the two mounting framework bodies 911, thus reducing the volume of the power transmission vehicle device, so as to reduce the floor space of the workshop to reduce the investment cost.

In addition, the first legs 911a of each mounting framework body 911 can also be used for wiring, which can rationalize the wiring of the power transmission vehicle device.

In one embodiment, the reliable connection between the insulating connecting component 930 and the mounting framework and the support framework 920 can also improve the support stability of the base frame 900.

Referring to FIG. 42, in one embodiment, the base frame 900 also comprises an insulating fastening component 940, the insulating fastening component 940 is configured to be detachably and fixedly connected with the first contact part 911c, the insulating connecting component 930 and the support framework 920, and the insulating fastening component 940 makes the connection between the first contact part 911c, the insulating connecting component 930 and the support framework 920 more reliable, so as to further enhance the support stability of the base frame 900.

In some embodiments, the insulating fastening component 940 comprises an insulating fastening body, an insulating bolt and an insulating nut, the insulating fastening body is provided with a bolt via hole penetrating the surface thereof along the first direction, and the insulating bolt is matched with the insulating nut by penetrating the bolt via holes of the insulating fastening body, the first contact part 911c, the insulating connecting component 930 and the support framework 920 in sequence so that the first contact part 911c, the insulating connecting component 930 and the support framework 920 are detachably connected.

In the above embodiments, the insulating fastening body comprises a first end, an intermediate part and a second end, and the intermediate part is connected between the first end and the second end to form a concave shape, wherein at least one of the first end, the intermediate part and the second end is provided with a bolt via hole penetrating the surface thereof along the first direction so that the insulating fastening component 940 has a notch through which, surrounding the first leg 911a, the first contact part 911c, the insulating connecting component 930 and the support framework 920 are connected more reliably by matching of the insulating bolt and the insulating nut.

In one embodiment, the insulating fastening body, the insulating bolt and the insulating nut can be made of an insulating material well known in the art or can be provided with an insulating layer on the surface thereof, the insulating layer is also made of an insulating material well known in the art, and the insulating material can be plastic, quartz or high-temperature resistant rubber, which is also not specified in the embodiments of this description.

In one embodiment, the ratio of the area S1 of a first surface of the insulating connecting component 930 to the contact area S3 of the mounting framework 910 and the insulating connecting area is (2-5):1. When the ratio of the area S1 of the first surface to the contact area S3 is within the above range, the creepage distance between the mounting framework 910 and the support framework 920 can be increased, the material can be saved, and the manufacturing cost can be reduced.

In one embodiment, the area S11 of the first surface of the insulating connecting area is greater than or equal to the contact area S3 of the mounting framework 910 and the insulating connecting area, which can contribute to further increasing the creepage distance between the mounting framework 910 and the support framework 920 and reduce the probability of electrical breakdown, so as to further improve the power transmission safety of the power transmission vehicle device.

It can be understood that the first surface of the insulating connecting area is located within the first surface of the insulating connecting component 930.

In some examples, the contact surface of the mounting framework 910 and the insulating connecting area is located in the central area of the first surface of the insulating connecting area, which can further make the creepage distances between the positions of the mounting framework 910 and the corresponding positions of the support framework 920 approximate each other, so as to further reduce the probability of electrical breakdown, thus improving the power transmission safety of the power transmission vehicle device.

Referring to FIG. 41, in one embodiment, the support framework 920 comprises at least three second legs 921, a second connecting part 922 and a second contact part 923. The second connecting part 922 is connected between two adjacent second legs 921 so that at least three second legs 921 are enclosed to form the body of the support framework 920. The second contact part 923 is arranged on a second end of the second leg 921, and the contact surface area of the second contact part 923 is larger than the surface area of the second end of the second leg 921. The insulating connecting component 930 is connected between the first contact part 911c and the second contact part 923, and the insulating fastening component 940 is configured so that the insulating connecting component 930, the first contact part 911c and the second contact part 923 are detachably and fixedly connected.

In the above embodiments, the support framework 920 is composed of at least three second legs 921. a second connecting part 922 and a second contact part 923, which can provide a good support for the mounting framework 910 and also enhance the support stability of the base frame 900.

It should be noted here that the surface area of the second contact part 923 can be understood as the contact area S4.

In the above embodiments, the ratio of the area S2 of a second surface of the insulating connecting component 930 to the contact area S4 of the support framework 920 and the insulating connecting area is (2-5):1. When the ratio of the area S2 of the second surface to the contact area S4 is within the above range, the creepage distance between the mounting framework 910 and the support framework 920 can be increased, the material can be saved, and the manufacturing cost can be reduced.

Moreover, in the above embodiments, the area S21 of the second surface of the insulating connecting area is greater than or equal to the contact area S4 of the support framework 920 and the insulating connecting area, which can contribute to further increasing the creepage distance between the mounting framework 910 and the support framework 920 and reduce the probability of electrical breakdown, so as to further improve the power transmission safety of the power transmission vehicle device.

It can be understood that the second surface of the insulating connecting area is located within the second surface of the insulating connecting component 930.

In some examples, the contact surface of the support framework 920 and the insulating connecting area is located in the central area of the second surface of the insulating connecting area, which can further make the creepage distances between the positions of the support framework 920 and the corresponding positions of the mounting framework 910 approximate each other, so as to further reduce the probability of electrical breakdown, thus improving the power transmission safety of the power transmission vehicle device.

In the above embodiments, a first reinforcing rib can be arranged between the first leg 911a and the first connecting part 911b in the mounting framework 910, which can further improve the structural strength of the mounting framework 910, so as to improve the support stability of the mounting framework 910.

Moreover, a second reinforcing rib can be arranged between the second leg 921 and the second connecting part 922 in the support framework 920.

In one embodiment, the creepage distance between the support framework 920 and the mounting framework 910 is 10-150 cm.

### Embodiment 8

Different from conventional workpieces, the power transmission busbar clamping mechanism 3000 mainly comprises a busbar clamping component 200 and a base frame. When the busbar clamping component 200 is arranged at the top of the base frame, the power transmission vehicle device is too high, the height cannot be adjusted, it is difficult to find a truck with a van of appropriate height, and the loading and transportation costs are relatively high. In this way, the present embodiment specifically adopts the following structure to solve the technical problem of inconvenience for loading and transportation due to that the power transmission vehicle device is too high and the height cannot be adjusted.

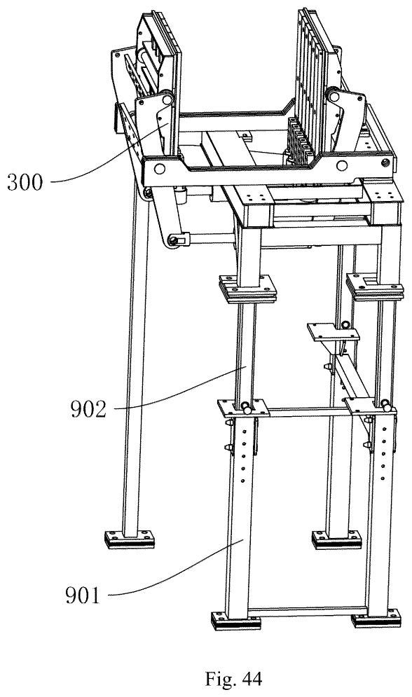

Referring to FIG. 44 to FIG. 47, the specific structure of the power transmission busbar clamping mechanism 3000 will be mainly described as follows.

The power transmission busbar clamping mechanism 3000 also comprises:

A base frame 900, which is arranged on the vehicle body 1000, wherein the busbar clamping component 200 is arranged on the base frame 900.

The base frame 900 comprises an upper bracket 902 and a lower bracket 901; the upper bracket 902 is nested into the lower bracket 901, the upper bracket 902 and the lower bracket 901 are provided with a plurality of second limiting holes, and the upper bracket 902 and the lower bracket 901 are connected by running limiting members through the respective second limiting holes to adjust the height of the whole base frame 900; and the busbar clamping component 200 is fixedly connected with the upper part of the base frame 900, and the opening of the busbar clamping component 200 is upward.

In the present embodiment, it should be noted that the busbar clamping component 200 and the upper part of the base frame 900 can be fixedly connected by welding, bolts or other modes.

Specifically, in one embodiment, the base frame 900 comprises a mounting frame 9022; the mounting frame 9022 is arranged at the top of the base frame 900; and the busbar clamping component 200 is fixedly connected with the mounting frame 9022.

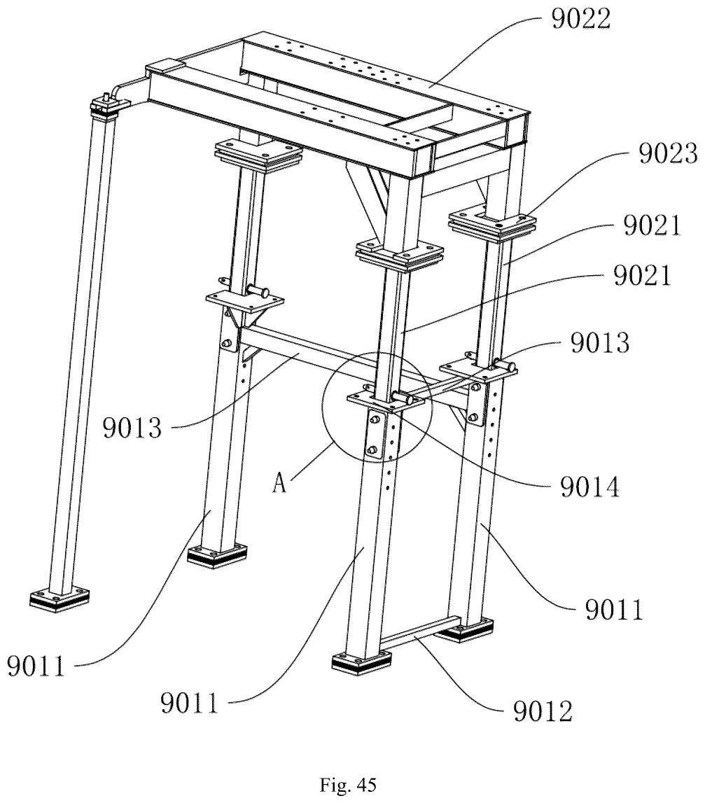

Referring to FIG. 44 and FIG. 45, the busbar clamping component 200 can be connected to the mounting frame 9022 of the base frame 900 by welding or by bolts.

In one embodiment, the lower bracket 901 comprises a first support pillar 9011 and a third support plate 9014; the third support plate 9014 is fixedly arranged at the top of the first support pillar 9011; the upper bracket 902 comprises a second support pillar 9021, and the limiting members comprise a first limiting member 9031; and the upper bracket 902 and the lower bracket 901 are connected by running the first limiting member 9031 through the second limiting hole of the second support pillar 9021, wherein the first limiting member 9031 is pressed against the third support plate 9014 under the action of gravity.

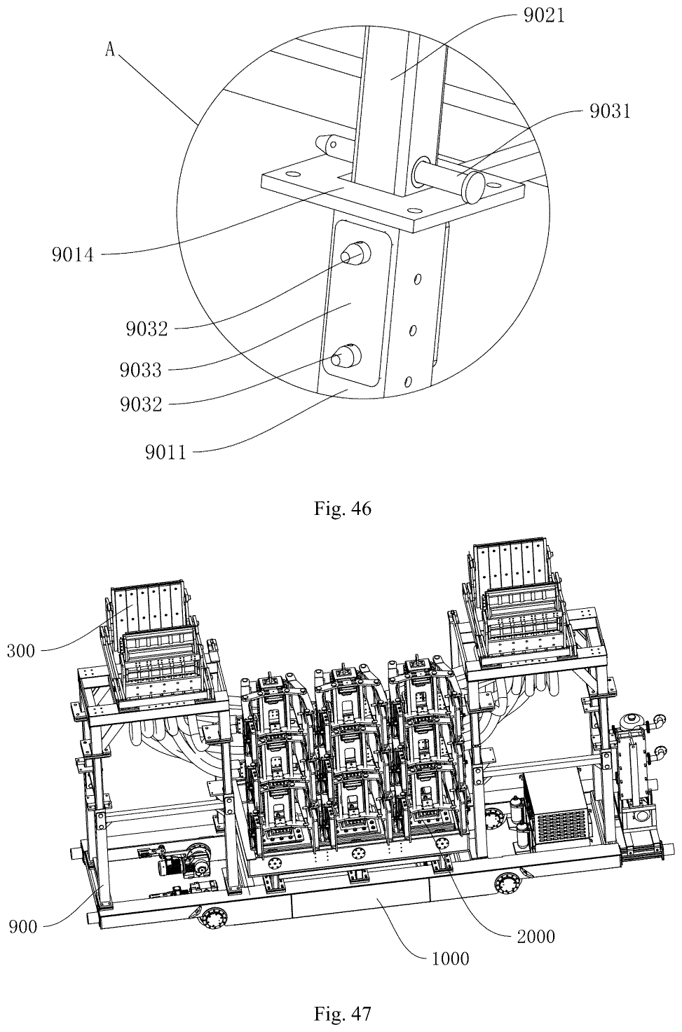

See FIG. 45 and FIG. 46.

In this embodiment, it should be noted that the upper bracket 902 comprises four second support pillars 9021, and the second support pillars 9021 are fixedly welded or connected by bolts below the mounting frame 9022 and specifically arranged on the ends of the mounting frame 9022.

The first support pillar 9011 and the second support pillar 9021 can have a hollow columnar structure, and the cross sectional area of the first support pillar 9011 is slightly larger than that of the second support pillar 9021 so that the second support pillar 9021 is just nested into the first support pillar 9011.

The third support plate 9014 and the first support pillar 9011 can be integrated in one piece, or the third support plate 9014 can be welded on the first support pillar 9011.

The second limiting holes of the upper bracket 902 can be arranged in the second support pillar 9021. The second limiting holes are arranged in pair in opposite sides of the second support pillar 9021 and each pair of second limiting holes are in the same horizontal line to ensure that the horizontal stability of the structure is maintained during penetration of the limiting members, and each pair of second limiting holes can be arranged in the front and back sides of the second support pillar 9021 or in the left and right sides of the second support pillar 9021.

The first limiting member 9031 can be a pin or other metal post, and the first limiting member 9031 is pressed against the third support plate 9014 by running the first limiting member 9031 through a pair of second limiting holes horizontally opposite in the second support pillar 9021 and under the action of gravity so that the upper bracket 902 and the lower bracket 901 are fixedly connected together, that is to say, the first support pillar 9011 and the second support pillar 9021 are fixedly connected together.

In the power transmission busbar clamping mechanism 3000 of the present application, the height of the whole base frame 900 can be adjusted by the arrangement that the upper bracket is nested into the lower bracket, and the upper bracket and the lower bracket are fixedly connected by arranging a plurality of second limiting holes and limiting members used for penetrating the second limiting holes in the upper bracket and the lower bracket and running the limiting members respectively through the second limiting holes at the same height in the upper bracket and the lower bracket. In the transportation scenario, the upper bracket is nested more in the lower bracket to adjust to an appropriate height, and then the limiting members are run through the second limiting holes to fix the height of the whole bracket so that the height of the whole power transmission vehicle is reduced, which is more convenient for loading and transportation of the power transmission vehicle, thus reducing the loading and transportation costs. Moreover, the power transmission busbar clamping mechanism 3000 in the present application can be adjusted adaptively to power transmission busbars of different heights based on the structural function of freely adjusting the height, so as to better adjust the position for reaching the power transmission busbars and clamp the power transmission busbars to ensure that the graphitization of the conducting electrodes is more stable after power on.

Based on the above embodiments, in one embodiment, the limiting members also comprise a second limiting member 9032; and the upper bracket 902 and the lower bracket 901 are also connected by running the second limiting member 9032 through the second limiting hole of the second support pillar 9021 and the second limiting hole of the first support pillar 9011.

See FIG. 45 and FIG. 46 for details.

In the present embodiment, the second limiting holes in the lower bracket 901 can be arranged in the first support pillar 9011, the second limiting holes are arranged in pair in opposite sides of the first support pillar 9011 and each pair of second limiting holes are in the same horizontal line to ensure that the horizontal stability of the structure is maintained during penetration of the limiting members, and each pair of second limiting holes can be arranged in the front and back sides of the first support pillar 9011 or in the left and right sides of the first support pillar 9011.

Similarly, the second limiting member 9032 can also be a pin or other metal post.

In order to further enhance the stability of connection between the upper bracket 902 and the lower bracket 901, the second limiting member 9032 can be run through the second limiting hole of the second support pillar 9021 and the second limiting hole of the first support pillar 9011, and a plurality of second limiting holes 9032 can be arranged. In this way, on the basis of arranging the second limiting member 9032 and the first limiting member 9031, the upper bracket 902 and the lower bracket 901 can be connected together more firmly to prevent shaking.

Moreover, preferably, the second limiting member 9032 and the first limiting member 9031 can be arranged in vertical and horizontal distribution, as shown in FIG. 46, which can ensure the stability of connection between the upper bracket 902 and the lower bracket 901 to a maximum extent.

Based on the above embodiment, in one embodiment, the external surfaces of opposite sides of the upper part of the first support pillar 9011 are provided with a patch plate 9033; the patch plate 9033 is provided with second limiting holes; and the upper bracket 902 and the lower bracket 901 are connected by running the second limiting member 9032 through the second limiting hole of the first support pillar 9011, the second limiting hole of the second support pillar 9021 and the second limiting hole of the patch plate 9033.

A pair of patch plates 9033 can be welded on the external surfaces of opposite sides (left and right or front and back) of the upper part of the first support pillar 9011 near the third support plate 9014, or the patch plates 9033 are not welded on both sides as long as the patch plates 9033 are close to both sides under the penetrating action of the second limiting member 9032.

Each patch plate 9033 is also provided with second limiting holes matched with the first support pillar 9011, and the upper bracket 902 and the lower bracket 901 can be connected by running the second limiting member 9032 through the second limiting hole of the first support pillar 9011, the second limiting hole of the second support pillar 9021 and the second limiting hole of the patch plate 9033.

The purpose of arranging the patch plates 9033 in the present embodiment is to avoid local force on the second limiting hole of the first support pillar 9011 and improve the load capacity of the second limiting hole, thus further improving the reliable stability of connection between the upper bracket 902 and the lower bracket 901.

Based on the above embodiments, in one embodiment, the base frame 900 also comprises a first cross strut 9012 and a second cross strut 9013; and the first cross strut 9012 and the second cross strut 9013 are arranged at intervals between a plurality of first support pillars 9011 respectively.

Referring to FIG. 45, the bottom of the first support pillar 9011 is also provided with a base. The first cross strut 9012 is arranged between the first support pillars 9011 and is close to the base.

The second cross strut 9013 is arranged between the first support pillars 9011 and is close to the third support plate 9014.

Specifically, for the arrangement of the first cross struts 9012 between a plurality of first support pillars 9011, first cross struts 9012 can be arranged between the first support pillars 9011, or a first cross strut 9012 can be optionally arranged between two first support pillars 9011, or no first cross strut 9012 is arranged between two first support pillars 9011.

Similarly, the second cross struts 9013 are arranged between a plurality of first support pillars 9011 in the same way as above, which will not be repeated here.

The present embodiment can improve the stability and load capacity of the base frame 900 by the arrangement of the cross struts.

Based on the above embodiments, in one embodiment, the second support pillar 9021 is provided with an insulating composite plate 9023; and the insulating composite plate 9023 comprises insulating mats and metal plates.

Specifically, in one embodiment, the insulating composite plate 9023 comprises two insulating mats and two metal plates; and the two insulating mats and the two metal plates are fixedly connected together, wherein the insulating mats and the metal plates are fitted adjacently.

In the preset embodiment, the two insulating mats and the two metal plates can be provided with through holes in the peripheries and fixedly connected together through bolts, wherein an insulating layer is arranged in each through hole, and the bolts are in direct contact with the insulating layers in the through holes.

The insulating mats and the metal plates can be fitted adjacently in the following ways: the insulating composite plate 9023 is provided with a first layer of insulating mat, a second layer of metal plate, a third layer of insulating mat and a fourth layer of metal plate from top to bottom in sequence. For the specific insulating composite plate 9023, the upper part of the second support pillar 9021 is welded with the second layer of metal plate together by penetrating the first layer of insulating mat, and the lower part of the second support pillar 9021 is directly welded with the fourth layer of metal plate together so that the insulating composite plate 9023 is arranged on the second support pillar 9021.

The purpose of arranging the insulating composite plate 9023 in the present embodiment is to make the power transmission busbar clamping mechanism 3000 above the insulating composite plate 9023 normally conducting and the power transmission busbar clamping mechanism 3000 below the insulating composite plate 9023 non-conducting to ensure electrical safety and prevent electric shock.

The above embodiments only express several implementation modes of the present application, and are described more specifically in details, but shall not be consequently interpreted as a limitation to the scope of the present application. It should be noted that, for those ordinary skilled in the art, several deformations and improvements can also be made without departing from the concept of the present application, all of which belong to the protection scope of the present application. Therefore, the protection scope of the present application shall be subject to appended claims.

1. A power transmission vehicle device, comprising a vehicle body, electrode clamping mechanisms and power transmission busbar clamping mechanisms, wherein the electrode clamping mechanisms and the power transmission busbar clamping mechanisms are arranged on the vehicle body, the electrode clamping mechanisms are used for clamping conducting electrodes, the power transmission busbar clamping mechanisms and the electrode clamping mechanisms are electrically connected, each power transmission busbar clamping mechanism comprises a busbar clamping component, and the busbar clamping component is used for clamping a power transmission busbar.

2. The power transmission vehicle device according to claim 1, wherein each power transmission busbar clamping mechanism also comprises a base frame, each electrode clamping mechanism is also provided with a strut, an electrode clamping component is arranged on the strut, and the strut is arranged on the base frame; and the base frame is provided with a crossbeam, the busbar clamping component is arranged on the crossbeam, and the height of the upper end of the busbar clamping component is less than that of the upper end of the strut.

3. The power transmission vehicle device according to claim 2, wherein the bottom end of the base frame is hollow for installation of a power transmission busbar through a space below the base frame.

4. The power transmission vehicle device according to claim 2, wherein the busbar clamping opening of the busbar clamping component is arranged towards the ground and kept at a certain distance from the ground.

5. The power transmission vehicle device according to claim 4, wherein both sides of the base frame are provided with a limiting baffle plate respectively, the crossbeam is arranged above the limiting baffle plate, the outside part of the busbar clamping opening of the busbar clamping component is arranged near the two limiting baffle plates, and the limiting baffle plates are used for limiting the width of the busbar clamping opening of the busbar clamping component. Preliminary Amendment

6. The power transmission vehicle device according to claim 2, wherein the busbar clamping opening of the busbar clamping component is arranged horizontally and kept at a certain distance from the ground.

7. The power transmission vehicle device according to claim 2, wherein the busbar clamping component comprises:
a first support frame, which is fixed on the crossbeam;
two busbar clamping plates arranged oppositely, wherein the two busbar clamping plates realize clamping operation on a power transmission busbar together;
two first clamping arms, which are hinged with both sides of the first support frame respectively, wherein the two busbar clamping plates are arranged on the two first clamping arms respectively; and
a first driving part, which is arranged between the two first clamping arms and connected with the two first clamping arms respectively.

8. The power transmission vehicle device according to claim 7, wherein the first support frame is fixed on a crossbeam through a connecting frame, the connecting frame is provided with a connecting piece and fixedly arranged on the crossbeam through the connecting piece, both sides of the connecting frame are provided with a support part in an extending manner respectively, and the support parts are connected with the first support frame through bolts.

9. The power transmission vehicle device according to claim 7, wherein each power transmission busbar clamping mechanism also comprises:
limiting components arranged on both ends of the first support frame respectively, wherein the limiting components are used for limiting the direction of the opening formed by the two busbar clamping plates.

10. The power transmission vehicle device according to claim 9, wherein each limiting component comprises a first limiting plate arranged on the first support frame and a second limiting plate arranged on the first clamping arm, and the first limiting plate or the second limiting plate is provided with a limiting bolt.

11. The power transmission vehicle device according to claim 1, wherein the electrode clamping opening of the electrode clamping component is arranged on one side of the electrode clamping mechanism, and the busbar clamping opening of the busbar clamping component is arranged by protruding from the other side of the electrode clamping mechanism.

12. The power transmission vehicle device according to claim 11, wherein the height of the upper end of the power transmission busbar clamping mechanism is not greater than that of the upper end of the electrode clamping mechanism.

13. The power transmission vehicle device according to claim 11, wherein the height of the upper end of the power transmission busbar clamping mechanism is greater than a preset value of the height of the upper end of the electrode clamping mechanism.

14. The power transmission vehicle device according to claim 11, wherein each power transmission busbar clamping mechanism also comprises a first fixing seat, the busbar clamping component is arranged on the first fixing seat, the first fixing seat is provided with a sliding rail, the sliding rail is arranged horizontally and provided with a bracket, the busbar clamping component is arranged on the bracket, and the bracket is slid back and forth along the direction of the sliding rail.

15. The power transmission vehicle device according to claim 11, wherein each power transmission busbar clamping mechanism also comprises a second fixing seat, the busbar clamping component is arranged on the second fixing seat, the second fixing seat comprises two fixing frames, each fixing frame is provided with a sliding rail, the sliding rail is arranged vertically and provided with a bracket, the busbar clamping component is arranged on the bracket, and the bracket is slid back and forth along the direction of the sliding rail.

16. The power transmission vehicle device according to claim 1, wherein the busbar clamping component comprises busbar clamping plates, each busbar clamping plate comprises a second clamping plate and a second conducting plate, the back surface of the second clamping plate is provided with a water cooling pipeline, and the ends of the water cooling pipeline are provided with connecting holes for connecting circulating fluid; and the second conducting plate is arranged closely to the front surface of the second clamping plate.

17. The power transmission vehicle device according to claim 16, wherein the second clamping plate is also provided with a protecting shell, and the protecting shell comprises a side plate enclosing the water cooling pipeline and a cover plate covering the edge of the side plate; and the cover plate is provided with through holes corresponding to the connecting holes.

18. The power transmission vehicle device according to claim 17, wherein the water cooling pipeline comprises a first pipeline and a second pipeline arranged side by side along a second direction of the second clamping plate, a first protecting shell and a second protecting shell are arranged respectively corresponding to the first pipeline and the second pipeline, and an avoidance groove is arranged between the two protecting shells for a pivot to run through.

19. The power transmission vehicle device according to claim 1, wherein the busbar clamping component comprises two busbar clamping plates close to or away from each other, each busbar clamping plate comprises a second clamping plate, the inside surface of the second clamping plate is provided with a second conducting plate, an elastic pad is arranged between the second conducting plate and the second clamping plate, and the second conducting plate is divided into a plurality of conducting strips arranged in parallel.

20. The power transmission vehicle device according to claim 1, wherein the busbar clamping component comprises busbar clamping plates, each busbar clamping plate comprises a first clamping plate and a first conducting plate, the first conducting plate is arranged on the first clamping plate, and the first conducting plate is provided with a first conducting head and a second conducting head;
wherein the first conducting head is communicated with the first conducting plate through a first diversion tube, the second conducting head is communicated with the first conducting plate through a second diversion tube, and the first conducting plate is provided with a cooling channel.

21. The power transmission vehicle device according to claim 20, wherein the first conducting plate is integrated in one piece, a water inlet end of the cooling channel is connected with the first diversion tube, and a water outlet end of the cooling channel is connected with the second diversion tube.

22. The power transmission vehicle device according to claim 20, wherein the first conducting plate comprises at least one first copper sheet and at least one second copper sheet, the first copper sheet and the second copper sheet are arranged side by side, the first conducting head is fixedly connected to the first copper sheet, and the second conducting head is fixedly connected to the second copper sheet; and one end of the first diversion tube is connected with the first conducting head, the other end of the first diversion tube is connected with the first copper sheet, one end of the second diversion tube is connected with the second conducting head, the other end of the second diversion tube is connected with the second copper sheet, and the first copper sheet and the second copper sheet are connected through a third diversion tube.

23. The power transmission vehicle device according to claim 1, wherein the busbar clamping component comprises:
a first support frame;
two busbar clamping plates arranged oppositely, wherein the two busbar clamping plates realize clamping operation on a conducting busbar on a furnace body together;
two first clamping arms, which are hinged with both sides of the first support frame respectively, wherein the two busbar clamping plates are arranged on the two first clamping arms respectively; and each busbar clamping plate is hinged on the first clamping arm on the corresponding side through a second rotating shaft, and the busbar clamping plate can be arranged in a mode of swinging around the second rotating shaft; and
a first driving part, which is arranged between the two first clamping arms and connected with the two first clamping arms respectively;
wherein at least one first clamping arm is provided with a first elastomer, a limiting part is extended from the first elastomer in a bending manner, and the limiting part is abutted against one side of the busbar clamping plate.

24. The power transmission vehicle device according to claim 23, wherein the limiting parts of the two first elastomers are arranged on both sides of the second rotating shaft respectively.

25. The power transmission vehicle device according to claim 23, wherein the first clamping arm is provided with a first fixing plate, and the first elastomers are arranged on the first fixing plate at intervals.

26. The power transmission vehicle device according to claim 23, wherein the limiting part is provided with screw holes, a first limiting bolt is arranged in each screw hole, and one end of the first limiting bolt is abutted against one side of the busbar clamping plate.

27. The power transmission vehicle device according to claim 23, wherein the busbar clamping plate is convexly provided with a buffer block towards one side of the limiting part, and the buffer block is abutted against the limiting part.

28. The power transmission vehicle device according to claim 1, wherein each power transmission busbar clamping mechanism also comprises a base frame, and the base frame comprises:
a mounting framework, which is configured for installation of the busbar clamping component of the power transmission vehicle device;
a support framework, which is connected with the mounting framework along a first direction;
an insulating connecting component, which has an insulating connecting area and an insulating edge area arranged around the insulating connecting area, wherein the insulating connecting area is connected between the mounting framework and the support framework, the area S1 of a first surface of the insulating connecting component is greater than or equal to the contact area S3 of the mounting framework and the insulating connecting area, the area S2 of a second surface of the insulating connecting component is greater than or equal to the contact area S4 of the support framework and the insulating connecting area, and the first surface and the second surface are arranged oppositely.

29. The power transmission vehicle device according to claim 28, wherein the mounting framework comprises:
two mounting framework bodies, which are arranged at intervals along a second direction; and
a crossbeam, which is connected between the two mounting framework bodies and configured for installation of the busbar clamping component of the power transmission vehicle device;
wherein the first direction intersects with the second direction.

30. The power transmission vehicle device according to claim 1, wherein each power transmission busbar clamping mechanism also comprises a base frame, and the base frame comprises an upper bracket and a lower bracket; and the upper bracket is nested into the lower bracket, the upper bracket and the lower bracket are provided with a plurality of limiting holes, and the upper bracket and the lower bracket are connected by running limiting members through the respective limiting holes to adjust the height of the whole base frame;
the busbar clamping component is fixedly connected with the upper part of the base frame, and the opening of the busbar clamping component is upward.

31. The power transmission vehicle device according to claim 30, wherein the lower bracket comprises a first support pillar and a support plate; and the support plate is fixedly arranged at the top of the first support pillar;
the upper bracket comprises a second support pillar, and the limiting members comprise a first limiting member; the upper bracket and the lower bracket are connected by running the first limiting member through a limiting hole of the second support pillar; and the first limiting member is pressed against the support plate under the action of gravity.
